(19) United States
(12) Patent Application Publication
(10) Pub. No.: US 2010/0074932 A1
(43) Pub. Date: Mar. 25, 2010

(54) ANTIMICROBIAL COMPOSITIONS CONTAINING GALLIUM

(76) Inventor: Silke Talsma, Tucker, GA (US)

Correspondence Address: GREENBLUM & BERNSTEIN, P.L.C., 1950 ROLAND CLARKE PLACE, RESTON, VA, 20191, US

(21) Appl. No.: 12/442,036

(22) PCT Filed: Sep. 20, 2007
(86) PCT No.: PCT/US07/78968

§ 371 Date: Oct. 14, 2009

Related U.S. Application Data
(60) Provisional application No. 60/826,566, filed on Sep. 22, 2006.

(51) Int. Cl. A01N 25/34; A01N 59/16; A01N 55/02; A01N 59/20; A01P 1/00; B05D 3/02; B05D 1/18; B28B 5/00

(52) U.S. Cl. 424/409; 424/650; 514/492; 424/618; 424/649; 424/641; 424/630; 514/495; 427/372.2; 427/430.1; 264/241

(57) ABSTRACT

Antimicrobial compositions may provide varying release kinetics for the active ions in the compositions due to the different water solubilities of the ions, allowing antimicrobial release profiles to be tailored for a given application and providing for sustained antimicrobial activity over time. According to some embodiments, the antimicrobial compositions may comprise polymer compositions containing colloids including salts of one or more oligodynamic metals, such as gallium. The antimicrobial compositions may be produced, for example, by mixing a solution of the salts of one or more oligodynamic metals with a polymer solution or dispersion and precipitating a colloid of the metal salts by addition of other salts to the solution which react with the metal salts. The compositions can be incorporated into articles or can be employed as a coating on articles such as medical devices including, for example, catheters, implants, and endotracheal tubes. The coatings may be on all or part of a surface.

### CROSS-REFERENCE TO RELATED APPLICATIONS

This patent application claims priority from U.S. Provisional Patent Application No. 60/826,566 entitled, “Antimicrobial Compositions Containing Gallium” filed on Sep. 22, 2006.

### TECHNICAL FIELD

The present invention relates generally to polymer compositions and their use for making and/or coating articles, such as medical devices More specifically the invention relates to antimicrobial compositions containing a polymer and at least one oligodynamic metal.

### SUMMARY OF THE INVENTION

According to some embodiments, the composition of the present invention may comprise at least one polymer and a colloid comprising a gallium compound, wherein the composition exhibits an antimicrobial effect.

In some embodiments, the gallium in the gallium compound in the aforementioned composition is present in a concentration from about 0.01 to about 4 mM with respect to the composition.

In some embodiments, the gallium in the gallium compound in the aforementioned composition is present in a concentration from about 0.06 to about 0.2 mM with respect to the composition.

In some embodiments, the gallium compound in the aforementioned composition includes at least one salt or ester of gallium.

In some embodiments, the gallium compound in the aforementioned composition includes at least one of gallium nitrate, gallium chloride, gallium iodide, gallium citrate, gallium acetate, and gallium lactate.

In some embodiments, the colloid in the aforementioned composition may further include at least one oligodynamic metal compound.

In some embodiments, the at least one oligodynamic metal compound in the aforementioned composition is chosen from silver, platinum, gold, zinc, copper, cerium, osmium, or mixtures thereof.

In some embodiments, the at least one oligodynamic metal compound in the aforementioned composition includes at least one silver compound which is a salt or ester of silver.

In some embodiments, the aforementioned composition with at least one silver compound can include at least one of silver chloride, silver iodide, silver citrate, silver lactate, silver acetate, silver propionate, silver salicylate, silver bromide, silver ascorbate, silver laurel sulfate, silver phosphate, silver sulfate, silver oxide, silver benzoate, silver carbonate, silver sulfadiazine, and silver gluconate.

In some embodiments, the at least one silver compound in the aforementioned composition can include silver compound is silver chloride in an amount of from about 4% to about 6% based on the total weight of solids in the composition.

In some embodiments, the gallium compound in the aforementioned composition can include at least one oligodynamic metal compound have different solubilities in water.

In some embodiments, the polymer of the aforementioned composition can include at least one polymer including at least one of polyurethanes, including polyether polyurethanes, polyester polyurethanes, polyurethaneureas and their copolymers, polyvinylpyrrolidones, polycarbonates, acrylates, polyvinyl alcohols, polyethylenes, polyethylene glycols and their copolymers, polypropylene glycols and their copolymers, polyoxyethylenes and their copolymers, polyacrylic acid, polyacrylamide, glycoproteins, proteoglycans, glycosaminoglycans, lipoproteins, liposaccharides, cellulose and its derivatives, dextrans, polysaccharides, starches, guar, xantham and other gums, collagen, gelatins, polytetrafluoroethylenes, polyvinyl chloride, polyvinyl chloride plastisol, polyvinylacetate, poly(ethylene terephthalate), silicone, polyesters, polyamides, polyureas, styrene-block copolymers, polymethyl methacrylate, acrylic-butadiene-styrene copolymers, polyethylene, polystyrene, polypropylenes, natural and synthetic rubbers, latex rubber, acrylonitrile rubber, and mixtures and derivatives and copolymers thereof.

In some embodiments, an article may comprise the aforementioned composition.

In some embodiments, the article includes a substrate material and a coating comprising the aforementioned composition on at least part of one or more surfaces of the substrate material.

In some embodiments, the article includes a surface of the substrate material that is not completely covered by the coating comprising the aforementioned composition.

In some embodiments, the article includes a part of the surface that is not covered is sufficiently transparent to allow visual inspection of the interior of the article

In some embodiments, the article includes a coating that comprises at least two layers.

In some embodiments, the article includes a medical device.

In some embodiments, the article includes a medical device that is chosen from endotracheal tubes, catheters, stents, syringes, guide wires, intrauterine devices, peristaltic pump chambers, gastroenteric feeding tubes, endoscopes, and arteriovenous shunts.

In some embodiments, the concentration of gallium in the gallium compound in the aforementioned article is about 0.06 to about 0.2 mM with respect to the composition.

In some embodiments, a method of manufacturing an article includes preparing a liquid comprising a composition with at least one polymer and a colloid comprising a gallium compound, and drying the liquid to create an article.

In some embodiments, a method of manufacturing an article includes, applying the aforementioned composition to a substrate, and drying the composition to form the article.

In some embodiments, a method of manufacturing an article includes, applying the aforementioned composition to a substrate, forming the composition with on the substrate, and drying the composition to form the article.

In some embodiments, in the method of manufacturing an article, the drying of the composition includes applying heat.

In some embodiments, in the method of manufacturing an article, the composition can be applied by at least one of spraying and dipping.

In some embodiments, a method of manufacturing an article includes dipping a form in the aforementioned composition.

In some embodiments, in the method of manufacturing an article, the composition is removed from the form.

In some embodiments, in the method of manufacturing an article, the article is prepared by injection molding, extruding, or casting the aforementioned composition.

In some embodiments, a method for delivery of one or more oligodynamic compounds comprising gallium includes implanting, administering, inserting, or placing the aforementioned composition under conditions effective to deliver the gallium to a desired location.

In some embodiments, the gallium compound in the method for delivery comprises at least one of gallium nitrate, gallium chloride, gallium iodide, gallium citrate, gallium acetate, and gallium lactate.

In some embodiments, a method of treating at least one cell, tissue, organism, or portion of the cell, tissue, or organism, comprising implanting, administering, inserting, or otherwise placing the aforementioned composition under conditions effective to deliver gallium to the cell, tissue, organism, or portion of the cell, tissue, or organism.

In some embodiments, a method of preparing an antimicrobial composition includes mixing at least one polymer with a liquid comprising at least one oligodynamic agent comprising a gallium compound.

In some embodiments, oligodynamic agent in the method of preparing an antimicrobial composition includes a gallium compound present in the form of a colloid.

In some embodiments, the colloid in the method of preparing an antimicrobial composition is formed by adding at least one salt comprising a cation chosen from calcium, sodium, lithium, aluminum, magnesium, potassium, manganese, silver, platinum, gold, cerium, osmium, copper, zinc, and gallium.

In some embodiments, the at least one salt in the method of preparing an antimicrobial composition further comprises an anion chosen from oxides, acetates, acetylsalicylates, ascorbates, benzoates, bitartrates, bromides, carbonates, chlorides, citrates, folates, carbonates, deoxycholates, gluconates, iodates, iodides, lactates, laurates, oxalates, palmitates, para-aminobenzoates, para-aminosalicylates, perborates, phenosulfonates, phosphates, picrates, propionates, salicylates, stearates, succinates, sulfadiazines, sulfates, sulfides, sulfonates, tartrates, thiocyanates, thioglycolates, thiosulfates, nitrates, and silver ethylenediaminetetraacetic acid, and combinations thereof.

In some embodiments, the at least one salt in the method of preparing an antimicrobial composition is added to the liquid comprising at least one oligodynamic agent comprising gallium after the gallium compound is mixed with the at least one polymer.

In some embodiments, the at least one salt in the method of preparing an antimicrobial composition is added to the liquid comprising at least one oligodynamic agent comprising gallium before the gallium compound is mixed with the at least one polymer.

### BRIEF DESCRIPTION OF THE DRAWINGS

FIG. 1 is a diagrammatic view of an endotracheal tube partially coated with a coating in accordance with some embodiments of the present invention.

FIG. 2 is a graph demonstrating the antimicrobial activity of gallium.

FIG. 3 is a graph demonstrating the competitive interference of gallium with iron metabolism.

FIG. 4 is a graph demonstrating the impact of gallium on biofilm formation.

FIG. 5 is a graph in demonstrating staggered release profiles of two oligodynamic agents.

### DETAILED DESCRIPTION

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values within that range. For example, if a range is from about 1 to about 50, it is deemed to include, for example, 1, 7, 34, 46.1, 23.7, or any other value within the range.

For many years silver and silver salts have been used as antimicrobial agents. An early medicinal use of silver was the application of aqueous silver nitrate solutions to prevent eye infection in newborn babies. Silver salts, colloids, and complexes have also been used to prevent and control infection. For example, colloidal metallic silver has been used topically for conjunctivitis, urethritis, and vaginitis.

Gallium including gallium salts, colloids, and complexes exhibit an antimicrobial effect, even in minute quantities, and have shown to be an effective antimicrobial for use with medical devices. As noted herein, the term “antimicrobial effect” includes, but is not limited to, inhibiting or preventing growth of, or killing, microorganisms. An antimicrobial effect can be exhibited in or around a composition.

The present invention relates generally to polymer compositions and their use in making or coating articles, such as, for example, medical devices. More specifically, the invention relates to antimicrobial compositions containing a polymer and at least one oligodynamic metal. Further, the present invention relates to compositions containing active agents as well as oligodynamic metals and their use.

The composition can be applied and/or coated on articles, or incorporated into articles during or after their manufacture. Any article can be coated with the compositions of the present invention. The composition is particularly suited for the production of medical devices, such as catheters, including, but not limited to, urinary catheters, vascular catheters, dialysis catheters, and port catheters, cannulae, plugs, stents, syringes, guide wires, implant devices, contact lenses, intrauterine devices (IUDs), peristaltic pump chambers, endotracheal tubes, gastroenteric feeding tubes, endoscopes (including arthroscopes), arteriovenous shunts, condoms, oxygenator and kidney membranes, diagnostic instruments, gloves, pacemaker leads, and wound dressings wherein the composition can exhibit antimicrobial effects. The composition can also be applied to any article in which antimicrobial effects are desired, such as, for example, toilet seats, hospital beds, door coverings, and trays.

### I. Compositions

Embodiments of the present invention provide antimicrobial compositions. The compositions generally comprise a polymer, and at least one colloid comprising an oligodynamic agent, such as gallium. The term “oligodynamic agents” as used in the present invention refers to any compound that can provide antimicrobial activity, even when present in small quantities. Oligodynamic agents are discussed in more detail below.

### A. Polymer

Any polymer may be employed in the present invention, and include, but are not limited to, hydrophilic polymers, hydrophobic polymers, and mixtures thereof. The choice of polymer depends on the qualities desired in the end product, in addition to overall components of the composition.

Hydrophilic polymers are generally soluble in water or in organic solvents containing some water. The ability to add water to the polymer composition without precipitating the polymer allows the addition of water-soluble salts directly to the coating composition. The use of water in the polymer composition increases the solubility of the salts, resulting in the formation of finer, more stable colloids. However, it takes longer for the coating compositions to dry when the water content is very high. For this reason, in some embodiments, the amount of water in the hydrophilic polymer compositions can be about 50% or less. In some embodiments, the polymer solution can contain from 1 to 50% water by weight. In an embodiment the polymer solution can contain from 5 to 30% water by weight. However, the use of water is not limiting, as salt colloids can also be formed using alcohols, organic solvents, or both that contain little or no water. Such concentrations may provide for faster drying times while maintaining the beneficial properties provided by the water in the composition.

The use of hydrophilic polymers can have additional benefits. These benefits include increased lubricity for patient comfort, increased absorption of aqueous fluids from the body, which aids in the release of oligodynamic ions from the composition, inhibition of bacterial attachment, and improved solubility for some metal salts.

When hydrophobic polymers are used either alone or in combination with hydrophilic polymers, it may be desirable to limit the amount of water present in the composition to avoid precipitation of the hydrophobic polymer with the colloid. Therefore, in some embodiments, the amount of water present in the polymer composition is 1% or less. While it is possible to practice the invention in the absence of water in the composition, it is desirable to have some water present. Thus, when hydrophobic polymers are employed in the present invention, in an embodiment the water content of the polymer compositions can be from about 0 to about 1% by weight. In an embodiment, salts that are soluble in alcohols or organic solvents are contemplated when hydrophobic polymers are employed.

Examples of polymers that may be used in the present compositions include, but are not limited to, polyurethanes, including polyether polyurethanes, polyester polyurethanes, polyurethaneureas, and their copolymers; polyvinyl pyrrolidones; polycarbonates; acrylates; polyvinyl alcohols; polyethylenes; polyethylene glycols and their copolymers; polypropylene glycols and their copolymers; polyoxyethylenes and their copolymers; polyacrylic acid; polyacrylamide; glycoproteins; proteoglycans; glycosaminoglycans; lipoproteins; liposaccharides; cellulose and its derivatives, for example, carboxymethyl cellulose; dextrans and other polysaccharides; starches; guar; xantham and other gums and thickeners; collagen; gelatins; other naturally occurring polymers; polytetrafluoroethylenes; polyvinyl chloride (PVC); PVC plastisol; polyvinylacetate; poly(ethylene terephthalate); silicone; polyesters; polyamides; polyureas; styrene-block copolymers; polymethyl methacrylate; acrylic-butadiene-styrene copolymers; polyethylene; polystyrene; polypropylenes; natural and synthetic rubbers; latex rubber; acrylonitrile rubber; and mixtures and derivatives and copolymers of any of the above

It is also possible to prepare polymer compositions from supercritical fluids. The most common of these fluids is liquefied carbon dioxide

In an embodiment, the polymer composition in which the colloid is formed can be a hydrophilic polyether polyurethaneurea. This polymer is a substantially noncovalently crosslinked reaction product of one or more diols, water and an organic diisocyanate. The urea segments of the polymer provide improved strength, increased viscoelasticity, and decreased water absorption. These polymers typically absorb water in amounts from 50 to 100% their weight while remaining strong and elastic.

Diols useful in the formation of these polymers include, but are not limited to, medium and long chain polyoxyethylene) glycols having a number average molecular weights between 250 and 20,000. Example of such diols are “CARBOWAX” compounds sold by Union Carbide.

Organic diisocyanates useful to form these polymers include, but are not limited to, tetramethylene diisocyanate, hexamethylene diisocyanate, trimethylhexamethylene diisocyanate, dimer acid diisocyanate, isophorone diisocyanate, diethylbenzene diisocyanate, decamethylene 1,10-diisocyanate, cyclohexylene 1,2-diisocyanate, cyclohexylene 1,4-diisocyanate, methylene bis(cyclohexyl-4-isocyanate), 2,4- and 2,6-tolylene diisocyanate, 4,4-diphenylmethane diisocyanate, 1,5-naphthaliene diisocyanate, dianisidine diisocyanate, tolidine diisocyanate, xylylene diisocyanate, and tetrahydronaphthalene-1,5-diisocyanate.

In an embodiment, the polymer composition can comprise a hydrophilic polymer as defined in U.S. Pat. No. 6,329,488, incorporated herein by reference, which is directed generally to a process for preparing silane copolymers. For example, U.S. Pat. No. 6,329,488 generally discloses the polymer can be polyurethane-urea-silane copolymer prepared from the following ingredients: (1) one or more polyisocyanate, (2) one or more lubricious polymer having at least two functional groups, which may be the same or different and are reactive with an isocyanate functional group, and (3) one or more organo-functional silanes having at least two functional groups, which may be the same or different and are reactive with an isocyanate functional group and another functional group that is reactive with a silicone rubber substrate. While these copolymers may be prepared in a variety of ways, they may be prepared by first forming a prepolymer from the polyisocyanate(s) and lubricious polymer(s) followed by reaction with the organo-functional silane(s). A catalyst is optionally employed during reaction of the isocyanate with the polyol.

Isocyanates which can be useful to form polymers include, but are not limited to, 4,4′-diphenylmethane diisocyanate and position isomers thereof, 2,4- and 2,6-toluene diisocyanate (TDI) and position isomers thereof, 3,4-dichlorophenyl diisocyanate, dicyclohexylmethane-4,4′-diisocyanate (HMDI), 4,4′-diphenylmethane diisocyanate (MDI), 1,6-hexamethylene diisocyanate (HDI) and position isomers thereof, isophorone diisocyanate (IPDI), and adducts of diisocyanates, such as the adduct of trimethylolpropane and diphenylmethane diisocyanate or toluene diisocyanate.

Polyols which can be useful to form polymers include, but are not limited to, polyethylene glycols, polyester polyols, polyether polyols, modified polyether polyols, polyester ether polyols, castor oil polyols, and polyacrylate polyols, including Desmophen A450, Desmophen A365, and Desmophen A160 (available from Mobay Corporation, Pittsburgh, Pa.), poly(ethylene adipates), poly(diethyleneglycol adipates), polycaprolactone diols, polycaprolactone-polyadipate copolymer diols, poly(ethylene-terephthalate)diols, polycarbonate diols, polytetramethylene ether glycol, ethylene oxide adducts of polyoxypropylene dials, and ethylene oxide adducts of polyoxypropylene triols. In an embodiment, polyols can include, but are not limited to, castor oil and castor oil derivatives, such as DB oil, Polycin-12, Polycin 55, and Polycin 99F available from CasChem, Inc. In an embodiment, diols include, but are not limited to, Desmophen 651A-65, Desmophen 1300-75, Desmophen 800, Desmophen-550 DU, Desmophen-1600U, Desmophen-1920D, and Desmophen-1150, available from Mobay Corporation, and Niax E-59 and others available from Union Carbide (Danbury, Conn.).

Catalysts which can be useful to form polymers include, but are not limited to, tertiary amines, such as N,N-dimethylaminoethanol, N,N-dimethyl-cyclohexamine-bis(2-dimethyl aminoethyl) ether, N-ethylmorpholine, N,N,N′,N′,N″-pentamethyldiethylene-triamine, and 1-2(hydroxypropyl) imidazole, and metallic catalysts, such as tin, stannous octoate, dibutyl tin dilaurate, dioctyl tin dilaurate, dibutyl tin mercaptide, ferric acetylacetonate, lead octoate, and dibutyl tin diricinoleate.

Silanes which can be useful to form polymers include, but are not limited to, N-beta-(aminoethyl)-gamma-aminopropyl-trimethoxy silane and diamino-alkoxysilanes, such as N-(2-aminoethyl)-3-aminopropylmethyl-dimethoxy silane.

In an embodiment, the polymers can have from 7 to 12% by weight silane based upon the weight of the entire polymer. In an embodiment, the ratio of isocyanate functional groups to alcohol or other isocyanate reactive functional groups can be from 11:1 to 2:1. Viscosity of the polymer solution is a function of molecular weight of the polymer and the solids content of the solution and is controlled by addition of solvent to the solution. In an embodiment, the copolymer solution for dip coating can have a kinematic viscosity in the range of about 1.5 cS to about 20 cS (centistokes), and a solids content in a range of about 0.4 to about 5.

In an embodiment, the polymer composition comprises a solution of a hydrophilic polymer, for example, as defined in U.S. Pat. No. 5,290,585, which is hereby incorporated by reference. For example, U.S. Pat. No. 5,290,585 generally discloses the polymer can be polyurethane-polyvinyl pyrrolidone prepared by mixing the appropriate amounts of isocyanate, polyol, and polyvinyl pyrrolidone (PVP) stock solution. Additional solvents can be added to adjust the viscosity and solids content. Solids content may be in the range of 0.4 to 15% by weight, depending on the solvent used and other considerations. The stoichiometric ratio of total NCO groups in the isocyanate to total OH groups in the polyol may vary from 0.75 to 3.0. In an embodiment, the isocyanate has at least two NCO groups per molecule and the polyol has at least two OH groups per molecule. The ratio of polyurethane formed in situ to PVP can range from 0.05 to 3.0 by weight

The PVP employed to form these polymers can have a mean molecular weight from about 50,000 to 2.5 million Daltons. In an embodiment, PVP polymers are Kollidon 90, Luviskol K90, Luviskol K80, and Luviskol K60, all available from BASF Corp. (Parsippany, N.J.) and Plasdone 90, PVP K90, and PVP K120, all available from GAF Corporation.

Isocyanates suitable to form these polymers can include, but are not limited to, polymethylenepolyphenyl isocyanate, 4,4′-diphenylmethane diisocyanate and position isomers thereof, 2,4-tolylene diisocyanate and position isomers thereof, 3,4-dichlorophenyl diisocyanate, isophorone isocyanate, and adducts or prepolymers of isocyanates, such as the isocyanate prepolymer available as Vorite 63 from CasChem, Inc (Bayonne, N.J.). Other examples of polyisocyanates useful in the present invention are those listed in ICI Polyurethanes Book, by George Woods, published by John Wiley and Sons, New York, N.Y. (1987).

Suitable solvents for use in the formation of these polymers can be those which are capable of dissolving the isocyanate, the polyol, and the polyvinyl pyrrolidone without reacting with any of these components. In an embodiment, solvents include, but are not limited to, methylene chloride, dibromomethane, chloroform, dichloroethane, and dichloroethylene.

The choice of polymer may depend upon the substrate to be coated. In an embodiment, the polymer comprises a polyurethane and polyurethane copolymers, such as polyether polyurethaneurea. In some embodiments, hydrophobic polymers that are chemically similar or identical to the substrate are used alone or in combination with hydrophilic polymers to form coatings that enhance adhesion of the coating to the substrate.

### B. Colloid

The colloid of the present invention generally comprises one or more oligodynamic metals, wherein the at least one oligodynamic metal comprises a gallium compound. It should be understood that the gallium compound can be gallium by itself, or a gallium compound with other materials. As described in detail below, oligodynamic metal cations come from the salts referred to as “salt A” It should be noted that the oligodynamic metals can be salts or esters, and can further be compounded with other elements or compounds such as nitrates or halides, e.g., chlorides, iodides, etc. It should be understood that in some embodiments, the oligodynamic salts can also comprise oxides. Therefore, the following references to “salt A” or “oligodynamic salts” can also include the aforementioned definition of oligodynamic metals. In some embodiments, the oligodynamic metal cation can comprise one or more salts or esters of oligodynamic metals. The salts or esters may be different salts or esters of the same oligodynamic metal, or may be salts or esters of different oligodynamic metals. In some embodiments, the oligodynamic metal cation is gallium. In some embodiments, the oligodynamic metal cation, for example gallium, can be combined with at least one additional oligodynamic metal cation such as silver, platinum, gold, zinc, copper, cerium, osmium, and the like.

In the compositions of the present invention, the colloids can be formed first and then added to the polymer composition or can be formed in situ in the composition comprising the polymer. In an embodiment, the colloids are formed in situ in the polymer composition.

Forming the colloids comprises, for example, combining two or more salts, wherein at least one of the salts is the salt of an oligodynamic agent, for example, gallium. These salts will be referred to as “salt A” and “salt B.” Salt A comprises one or more oligodynamic agents, for example, gallium. Salt B comprises one or more salts that can react with salt A to form a colloid. Salts A and B can be combined in any amount and in any order. In some embodiments, salt A is present in a stoichiometric amount or in excess when compared to salt B In some embodiments, salt B is present in a stoichiometric amount or in excess when compared to salt A.

Optionally, additional components can be added to the compositions. These additional components can include, but are not limited to, additional oligodynamic agents, additional soluble salts, salts which provide galvanic action, and any other components which provide the compositions with beneficial properties or enhance the overall antimicrobial effect of the compositions. Such components can include, but are not limited to, antimicrobial agents, antibiotics, and other medicinal agents.

In an embodiment, the composition can be produced by forming a solution, dispersion, or combination of solutions and suspensions of one or more polymers. Next, a solution comprising salt A can be added to the polymer composition. Then, a solution comprising salt B can be added to the polymer composition to precipitate fine colloidal salt(s) of the oligodynamic agent(s) of salt A. Where the oligodynamic agent is a metal salt, the metal cation of salt A can react with the anion of salt B. Salt B can be added to the polymer composition in an amount sufficient to react with some or all of salt A. Optionally, other salts can be added in amounts to react with some or all of the remaining amount of salt A.

In some embodiments, salt B can be added to the polymer composition, followed by the addition of an excess or stoichiometric amount of salt A. In yet another embodiment, salts A and B can be combined to form a colloid which is then added to the polymer composition

The final polymer composition formed by these processes can contain one or more colloidal salts, composed of the oligodynamic cations of salt A and the anions of salt B, and one or more soluble salts, composed of the anions of salt A and the cations of salt B. Additionally, other salts may be added to the composition that do not react in solution but provide some beneficial effect including but not limited to, stabilization of the colloid, modification of antimicrobial ion release rate, promotion of galvanic action, increase in antimicrobial effect, or enhancement of biocompatibility. Further, other compounds may be added to the composition, including, but not limited to, medicinal agents, lubricants, nutritional agents, antioxidants, dyes and pigments, and other additives.

In some embodiments of the compositions of the present invention, the formation of colloids within the polymer composition produces ultra-fine particles that possess a minimal particle size for the metal salts. This minimal particle size retards settling and agglomeration. The use of colloids in the composition can also permit incorporation of higher quantities of antimicrobial metal without the difficulties associated with the suspensions used in the prior art.

### C. Oligodynamic Agent

Oligodynamic agents of the present invention refer to any compound that can provide antimicrobial activity, even when present in small quantities. Oligodynamic agents include, but are not limited to, oligodynamic metals comprising salts or esters. As defined herein, oligodynamic metals comprising salts or esters also include, but are not limited to, oxides.

According to an embodiment, salt A may comprise gallium. In some embodiments, salt A may comprise gallium and at least one additional oligodynamic metal, such as, for example, silver, platinum, gold, zinc, copper, cerium, osmium, etc. In some embodiments, a composition comprising gallium may be incorporated into a coating, for example, a hydrogel coating with or without other antimicrobial agents such as, for example, other oligodynamic metals such as silver, platinum, gold, zinc, copper, cerium, osmium, etc. In an embodiment, gallium compounds may be incorporated into polymers which make up an article. In some embodiments, the composition comprising gallium may be applied to a preformed article or form such as, for example, a medical device such as a urinary catheter, endotracheal tube, etc. The gallium may prevent biofilm formation and/or exhibit an antimicrobial effect on the surface or vicinity of the article via several different mechanisms. While the exact mechanism of gallium as an antimicrobial is unknown, and not wishing to be bound by the following theories, it appears gallium may act as a competitive inhibitor of iron (i.e., it is iron-like, but not functional), and therefore interferes with the iron metabolism of bacterial microorganisms.

As described above, salts of other metals may be included in the colloid (referred to herein as “salt B”) These salts contain cations that include, but are not limited to, calcium, sodium, lithium, aluminum, magnesium, potassium, manganese, etc., and may also include oligodynamic metal cations such as silver, platinum, gold, cerium, osmium, copper, zinc, etc. These salts may contain anions that include, but are not limited to, acetates, acetylsalicylates, ascorbates, benzoates, bitartrates, bromides, carbonates, chlorides, citrates, folates, carbonates, deoxycholates, gluconates, iodates, iodides, lactates, laurates, oxalates, palmitates, para-aminobenzoates, para-aminosalicylates, perborates, phenosulfonates, phosphates, picrates, propionates, salicylates, stearates, succinates, sulfadiazines, sulfates, sulfides, sulfonates, tartrates, thiocyanates, thioglycolates, thiosulfates, etc., as well as silver proteins and silver ethylenediaminetetraacetic acid.

The invention may also be practiced with oxides serving as the anions of salt B, including, but not limited to, oxides of calcium, sodium, lithium, aluminum, magnesium, potassium, manganese, and the like, and may also include oligodynamic metal cations such as silver, platinum, gold, cerium, osmium, copper, zinc, and the like.

The compositions can also contain auxiliary components. Examples of such auxiliary components include, but are not limited to, viscosity and flow control agents, antioxidants, conventional pigments, surfactants, air release agents or defoamers, and discolorants. The composition may also contain dyes and pigments to impart color or radiopacity or to enhance the aesthetic appearance of the compositions. The compositions can also contain additional lubricating agents and other additives, which may enhance patient comfort and tissue health

Advantageous properties of some embodiments of the present compositions can result from the differences in the water solubility of the different metal salts present in the colloid. These differing solubilities of the metal salts in the colloid can provide varying release kinetics for the oligodynamic metal(s). For example, with a medical device composed of, or coated with, the compositions of the present invention, salts with a higher water solubility can be released from the coating relatively quickly, providing an initial dose of antimicrobial activity to kill bacteria introduced upon insertion of the device in the patient. This initial dose is sometimes referred to as “quick kill,” and this antimicrobial activity is identified by the ability of a coated device or composition to create zones of no bacterial growth around the device or composition when it is placed in a bacterial culture, commonly referred to as a “zone of inhibition” assay. Typically, salts having lower water solubilities will be released more slowly from the composition, resulting in a sustained or extended antimicrobial activity over time.

Selection of salts having varying degrees of solubility in the composition allows tailoring of the composition to the specific application of the article comprising the composition. In an embodiment, compositions of the invention can be tailored to kill bacteria introduced during the insertion of a medical device, both on the surface of the device and in the surrounding fluid and tissue, by the quick release of antimicrobial metal salts, followed by prolonged inhibition of bacterial migration and growth by the slower release of less soluble antimicrobial metal salts over an extended period of time. In an embodiment, the compositions contain gallium salts with a very low solubility, thus reducing the release of gallium into the fluid surrounding the article in order to reduce tissue exposure to gallium ions while maintaining inhibition of microbial adherence on the surface of the coated article The ability to tailor the release of the oligodynamic agent is advantageous over conventional antimicrobial compositions, as it provides for both immediate and sustained antimicrobial activity.

In an embodiment, the composition may contain any amount of one or more oligodynamic metal salts or esters, or combinations of metal salts and esters. As noted above, the oligodynamic metal salts can include, for example, oxides. In some embodiments, the composition may have upper and/or lower ranges or values of greater than zero, 1, 2, 2.5, 3, 4, 5, 6, 7, 8, 9, 10, 15, 20, 25, 30, 35, 40, 45, 50% or greater (based on weight of total solids in the composition) of the one or more oligodynamic metal salts, esters, or combination of salts and esters. In some embodiments, the composition may be about 5% to about 50%, about 10% to about 45%, about 15% to about 35%, about 20% to about 30%, or about 20% to about 25% (based on weight of total solids in the composition) of the one or more oligodynamic metal salts, esters, or combination of salts and esters.

In some embodiments, the composition can contain greater than 0 to about 8%, about 3% to about 6%, or about 4% to about 5% (based on weight of total solids in the composition) of the one or more oligodynamic metal salts, esters, or combination of salts and esters.

In an embodiment, the composition can contain about 5%, about 2.5%, or about 1% (based on weight of total solids in the composition) of the one or more oligodynamic metal salts, esters, or combination of salts and esters.

Based on total concentration of oligodynamic metal in the composition, in some embodiments, the composition may have upper and/or lower ranges or values of greater than 0, 0.01, 0,02, 0.04, 0.06, 0.08, 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, and 4.0 mM of the one or more oligodynamic metal salts, esters, or combination of salts and esters. In some embodiments, the composition can contain greater than zero and up to about 4 mM, about 0.2 mM to about 3.5 mM, about 0.3 mM to about 3.0 mM, about 0.4 mM to about 2.5 mM, or about 0.5 mM and about 2.0 mM of the one or more oligodynamic metal salts, esters, or combination of salts and esters.

Based on concentration of gallium in the composition, in some embodiments, the composition may have upper and/or lower ranges or values of greater than 0, 0.01, 0.02, 0.04, 0.06, 0.08, 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, and 4.0 mM of the one or more gallium metal salts, esters, or combination of salts and esters. In some embodiments, the composition can contain greater than zero and up to about 2 mM, about 0.2 mM to about 1.5 mM, about 0.3 mM to about 1.0 mM, about 0.4 mM to about 0.8 mM, about 0.5 mM and about 0.7 mM of the one or more gallium metal salts, esters, or combination of salts and esters.

### II. Methods of Making Composition

In an embodiment, the present invention relates to a process for producing the compositions of the invention. In general terms, the process comprises the formation of colloids of oligodynamic agents in polymer solutions or suspensions. As described above in the “Colloids” section, the colloids can be formed first and then added to the polymer composition or can be formed in situ in the polymer composition. In an embodiment, the colloids are formed in situ in the polymer composition.

Therefore, the process of forming the colloids comprises, for example, combining two or more salts, wherein at least one of the salts is the salt of an oligodynamic agent, for example, gallium, described above as “salt A” and “salt B.” Salt A comprises one or more oligodynamic agents, for example, gallium. Salt B comprises one or more salts that can react with salt A to form a colloid Salts A and B can be combined in any amount and in any order. In embodiments, salt A is present in a stoichiometric amount or in excess when compared to salt B. In embodiments, salt B is present in a stoichiometric amount or in excess when compared to salt A.

As described above, any polymer can be used to form the compositions of the present invention. Therefore, the use of hydrophilic or hydrophobic polymers, or mixtures thereof are contemplated.

As described above, the colloid of the present invention generally comprises one or more metals wherein the at least one oligodynamic metal comprises gallium. Examples of gallium salts suitable for use in the present invention include, but are not limited to, gallium nitrate, gallium acetate, gallium chloride, gallium iodide, gallium citrate, and gallium lactate. In addition, any gallium salt formed by mixing “Salt A” and “Salt B” is contemplated by the present invention. Persons skilled in the art will recognize that many of the “Salt B” salts described herein are soluble in water and suitable for use as a water-soluble salt herein. Examples of salts which are soluble in alcohols and organic solvents include, but are not limited to, gallium nitrate, sodium iodide, sodium lactate, sodium propionate, sodium salicylate, zinc chloride, zinc acetate, zinc salicylate, gold trichloride, gold tribromide, palladium chloride and hydrogen-hexachloroplatinate. Examples of alcohols that are useful in the present invention include, but are not limited to, methanol, ethanol, propanol, isopropanol, and butanol. Examples of organic solvents that can be used to form solutions or suspensions of the oligodynamic salts include, but are not limited to, acetone, tetrahydrofuran (THF), dimethylformamide (DMF), dimethlysulfoxide (DMSO), and acetonitrile. These organic solvents are especially useful when they contain a small amount of water.

In an embodiment, the polymer coating composition can comprise a combination of a hydrophilic polyurethane, a polymer that is similar or identical to the polymer substrate to be coated, and, optionally, other polymers that aid coating adhesion and physical properties. Antimicrobial salt colloids can be prepared in this composition as disclosed previously, with the exception that, depending on the second polymer used, some or all of the water used to prepare salt solutions or suspensions can be replaced with alcohols or other organic solvents to prevent precipitation of the second polymer.

In an embodiment, the salts elected can be soluble in solvents compatible with those in which the polymers are soluble. As an example, a solution of a hydrophilic polyether polyurethaneurea in THF can be combined with a solution of polyvinyl chloride (PVC) in methylene chloride or THE in equal amounts. Then, gallium nitrate can be dissolved in ethanol and added to the solution without precipitation. Ethanol can be used to dissolve the gallium nitrate instead of water because PVC has a tendency to precipitate when water is added to the solution. Finally, a dilute solution of zinc chloride in ethanol/water can be slowly added to the polymer composition to produce a fine gallium chloride colloid without precipitation of the PVC The final concentration of water in the coating is less than 1%. The coating solution is then used to dip-coat PVC catheters, endotracheal tubes, or other devices. The finished coating typically adheres well and provides a durable and lubricious coating when wetted, and further contains colloidal antimicrobial salts.

When a composition containing this polymeric solution is to be used as a coating, the coating can be cured, after application to the substrate, at a temperature in the range of approximately 75° F. to approximately 350° F. for a period in the range of about 2 minutes to about 72 hours.

A. Incorporation of Additional Active Agents into the Composition

The compositions of the present invention can also contain additional components. For example, the composition can include agents that affect the release of the at least one oligodynamic metal in the composition.

In some embodiments, the compositions of the present invention can contain one or more additional active agents in addition to the oligodynamic metal salts, esters or oxides. The active additional agents can be either retained in the composition or released from the composition at a desired rate or having a desired release profile Nonlimiting examples of such additional active agents can include antimicrobial agents, such as antibacterial agents, immune boosting agents, anticancer agents, angiogenic agents, polymyxins, antifungal agents, antiviral agents and antibiotics; growth factors, cytokines, immunoglobulins, pharmaceuticals, nutraceuticals, angiostatic agents, including, but not limited to, antithrombogenic agents, antitumoral agents, growth factors, antiangiogenic agents, spermicides, anesthetics, analgesics, vasodilation substances, wound healing agents, plant extracts, and other therapeutic and diagnostic agents. The compositions can also contain salts of metals that enhance the antimicrobial effect of the oligodynamic metal, such as the platinum group metals, or other metals that promote galvanic action. In some embodiments, the combination of additional antimicrobial compounds with oligodynamic metal compounds provide for enhanced antimicrobial activity, for example, by resulting in synergistic antimicrobial activity.

The additional active agent can be present in the composition in any amount. In some embodiments, amounts can include from about 0 1% to about 50%, or about 1% to 30% of the composition based upon the dry weight of the composition.

It will be understood by one of ordinary skill in the art that these are nonlimiting examples and that other additional active agents can be incorporated into the copolymers of the present invention in a manner similar to the incorporation of the specifically recited additional active agents.

In some embodiments, the additional active agent can comprise one or more biguanides. As used herein, the term “biguanide” includes poly (hexamethylene biguanide) hydrochloride and chlorhexidine compounds Chlorhexidine is the term denoting the chemical compound N,N″-bis(4-chlorophenyl)-3,12-diimino-2,4,11,13-tetraaz-atetradecanediimidamide (CAS registry number 55-56-1) Chlorhexidine compounds include chlorhexidine free base as well as chlorhexidine salts, including but not limited to chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine di-iodobutyrate, chlorhexidine di-n-valerate, chlorhexidine dicaproate, chlorhexidine malonate, chlorhexidine succinate, chlorhexidine succinamate, chlorhexidine malate, chlorhexidine tartrate, chlorhexidine dimonoglycolate, chlorhexidine mono-diglycolate, chlorhexidine dilactate, chlorhexidine di-alpha-hydroxyisobutyrate, chlorhexidine diglucoheptonate, chlorhexidine di-isothionate, chlorhexidine dibenzoate, chlorhexidine dicinnamate, chlorhexidine dimandelate, chlorhexidine di-isophthalate, chlorhexidine isoethionate chlorhexidine di-2-hydroxy-napthoate, and chlorhexidine embonate Chlorhexidine salts can include the acetates, formates, gluconates, hydrochlorides, isoethionates, lactates, and succinamates of chlorhexidine. These biguanide compounds are known in the art and can be prepared by conventional methods. Numerous other biguanides are known and contemplated for use by the present invention. Biguanides can also form polymers. Use of these biguanide polymers is also contemplated by the present invention.

In an embodiment, chlorhexidine can be used as an active agent because it can provide antimicrobial activity. Any effective amount of chlorhexidine can be used. In some embodiments, chlorhexidine can be used in an amount greater than 0 and up to about 50% based on total solids in the composition by weight. In some embodiments, chlorhexidine can be used in an amount greater than 0 and up to about 10% based on total solids in the composition by weight. In some embodiments, chlorhexidine can be used in an amount from about 10% to about 50%, from about 2 to about 10%, from about 10% to about 20%, from about 20% to about 30% based, from about 25% to about 50%, from about 30% to about 40%, or from about 40% and about 50% based on total solids in the composition by weight.

In some embodiments, the additional active agent can comprise one or more chlorinated phenols. Chlorinated phenol compounds which may be used according to the invention include but are not limited to parachlorometaxylenol, dichlorometaxylenol, triclosan (2,4,4′-trichloro-2 hydroxy di-phenyl ether), 2-chlorophenol, 3-chlorophenol, 4-chlorophenol, 2,4-dichlorophenol, 2,4,6-trichlorophenol, 2,3,4,6-tetrachlorophenol, pentachlorophenol, 4-chlororesorcinol, 4,6-dichlororesorcinol, 2,4,6-trichlororesorcinol, alkylchlorophenols (including p-alkyl-o-chlorophenols, o-alkyl-p-chlorophenols, dialkyl-4-chlorophenol, and tri-alkyl-4-chlorophenol), dichloro-m-xylenol, chlorocresol, o-benzyl-p-chlorophenol, 3,4,6-trichlorphenol, 4-chloro-2-phenylphenol, 6-chloro-2-phenylphenol, o-benzyl-p-chlorophenol, and 2,4-dichloro-3,5-diethylphenol. In an embodiment, chlorinated phenols can include triclosan and parachlorometaxylenol.

In some embodiments, the additional active agent can comprise one or more quaternary ammonium compounds including but not limited to monomeric and polymeric quaternary ammonium compounds. Examples of quaternary ammonium compounds include, but are not limited to, benzalkonium chloride, benzethonium chloride, other benzalkonium or benzethonium halides, cetylpyridinium chloride, dequalinium chloride, N-myristyl-N-methylmorpho-linium methyl sulfate, poly[N-[3-(dimethylammonio)propyl]-N′-[3-(ethyleneo-xyethylene dimethylammonio)propyl]urea dichloride], alpha-4-[1-tris(2-hydroxyethyl) ammonium chloride-2-butenyl]-omega-tris(2-hydroxyethyl)ammonium chloride, alpha-4-[1-tris(2-hydroxyethyl)ammonium chloride-2-butenyl]poly[1-dimethyl ammonium chloride-2-butenyl]-omega-tri-s(2-hydroxyethyl)ammonium chloride, poly[oxy-ethylene(dimethyliminio)ethylene (dimethyliminio)-ethylene dichloride], ethyl hexadecyl dimethyl ammonium ethyl sulfate, dimethyl ammonium ethyl sulfate, dimethylethylbenzyl ammonium chloride, dimethylbenzyl ammonium chloride, and cetyldimethylethyl ammonium bromide. In an embodiment, the quaternary ammonium compound can be benzalkonium chloride.

In some embodiments, the additional active agent can comprise typical antimicrobial, antiinfective, antiviral, and antibacterial agents agents, cytokines, immunoglobulins, or pharmaceuticals and nutraceuticals For example, these additional active agents can include, but are not limited to, alexidine, aminoglycosides (such as gentamicin and Tobramycin), amoxicillin, amphotericin, ampicillin, bacitracin, beclomethasone, benzocaine, benzoic acid, beta-lactams such as pipracil and aztneonam, betamethasone, biaxin, cephalosporins such as ceftazidime, cetrimide, chloramphenicol, clarithromycin, clotrimazole, cyclosporin, docycline, erythromycin, ethylenediamine tetraacetic acid (EDTA), furazolidine, fusidic acid, gramicidin, iodine and iodine complexes such as povidone iodine and pluronic-iodine complex, macrolides, miconazole, minocycline, neomycin, nystatin, octenidine hydrochloride, ofloxacin, parachlorometaxylene, penicillin, pentoxifylline, phenolic compounds (e.g., orthophenylphenol), phenoxymethylpenicillin, picloxydine, polymixin, quinolone antibiotics (such as Norfloxacin, oxolinic acid, ciprofloxacin; Pefloxacin, Enoxacin, AM-833, Pipemidic acid and Piromidic acid, 6,8-difluoro-1-(2-fluoroethyl)-1,4-dihydro-4-oxo-7-(4-methyl-1-piperazinyl)-quinoline-3-carboxylic acid, naladixic acid, and salts thereof) rifampicin, sorbic acid, sulfamylon, sulfonamides, tetracycline, triclocarban, vancomycins, zithromax, derivatives, metabolites, and mixtures thereof, or compounds having similar antimicrobial activity.

In some embodiments, the additional active agent can comprise one or more growth factors. Examples of growth factors useful in the present invention include, but are not limited to, transforming growth factor-α (“TGF-α”), transforming growth factor-β (“TGF-β”), vascular epithelial growth factor (“VEGF”), basic fibroblast growth factor, insulin-like growth factor (IGF), vascular endothelial growth factor and mixtures thereof. Cytokines useful in the present invention include, but are not limited to, IL-1, IL-2, IL-3, IL-4, IL-5, IL-6, IL-7, IL-8, IL-9, IL-10, IL-11, IL-12, IL-13, TNF-α, and TNF-β. Immunoglobulins useful in the present invention include, but are not limited to, IgG, IgA, IgM, IgD, IgE, and mixtures thereof.

In some embodiments, the additional active agent can comprise one or more pharmaceutical agents. Examples of pharmaceutical agents that can be useful as active agents include, but are not limited to, nonoxynol 9, acebutolol, acetylcysteine, acetylsalicylic acid, acyclovir, AZT, alprazolam, alfacalcidol, allantoin, allopurinol, ambroxol, amikacin, amiloride, aminoacetic acid, aminodarone, amitriptyline, amlodipine, ascorbic acid, aspartame, astemizole, atenolol, benserazide, bezafibrate, biotin, biperiden, bisoprolol, bromazepam, bromhexine, bromocriptine, budesonide, bufexamac, buflomedil, buspirone, caffeine, camphor, captopril, carbamazepine, carbidopa, carboplatin, cefachlor, cefalexin, cefatroxil, cefazolin, cefixime, cefotaxime, ceftazidime, ceftriaxone, cefuroxime, selegiline, chloramphenicol, chlor-pheniramine, chlortalidone, choline, cilastatin, cimetidine, cisapride, cisplatin, clavulanic acid, clomipramine, clozapine, clonazepam, clonidine, codeine, cholestyramine, cromoglycic acid, cyanocobalamin, cyproterone, desogestrel, dexamethasone, dexpanthenol, dextromethorphan, dextropropoxiphen, diazepam, diclofenac, digoxin, dihydrocodeine, dihydroergotamine, dihydroergotoxin, diltiazem, diphenhydramine, dipyridamole, dipyrone, disopyramide, domperidone, dopamine, doxycycline, enalapril, ephedrine, epinephrine, ergocalciferol, ergotamine, estradiol, ethinylestradiol, etoposide, Eucalyptus globulus, famotidine, felodipine, fenofibrate, fenoterol, fentanyl, flavin mononucleotide, fluconazole, flunarizine, fluorouracil, fluoxetine, flurbiprofen, furosemide, gallopamil, gemfibrozil, gingko biloba, glibenclamide, glipizide, glycyrrhiza glabra, grapefruit seed extract, grape seed extract, griseofulvin, guaifenesin, haloperidol, heparin, hyaluronic acid, hydrochlorothiazide, hydrocodone, hydrocortisone, hydromorphone, ipratropium hydroxide, ibuprofen, imipenem, indomethacin, iohexol, iopamidol, isosorbide dinitrate, isosorbide mononitrate, isotretinoin, ketotifen, ketoconazole, ketoprofen, ketorolac, labetalol, lactulose, lecithin, levocamitine, levodopa, levoglutamide, levonorgestrel, levothyroxine, lidocaine, lipase, imipramine, lisinopril, loperamide, lorazepam, lovastatin, medroxyprogesterone, menthol, methotrexate, methyldopa, methylprednisolone, metoclopramide, metoprolol, miconazole, midazolam, minocycline, minoxidil, misoprostol, morphine, N-methylephedrine, naftidrofuryl, naproxen, nicardipine, nicergoline, nicotinamide, nicotine, nicotinic acid, nifedipine, nimodipine, nitrazepam, nitrendipine, nizatidine, norethisterone, norfloxacin, norgestrel, nortriptyline, omeprazole, ondansetron, pancreatin, panthenol, pantothenic acid, paracetamol, phenobarbital, derivatives, metabolites, and other such compounds have similar activity.

Other pharmaceutical agents useful in the present invention include, but are not limited to, antithrombogenic agents, anti-inflammatory agents, antitumoral agents, antiangiogenic agents, spermicides, anesthetics, analgesics, vasodilation substances, wound healing agents, other therapeutic and diagnostic agents, and mixtures thereof.

In an embodiment, the additional active agent can comprise one or more herbicide, insecticide, algaecide, antifoulant, antifogging agent, or UV or other screening agent. In an embodiment, these additional active agents are those which can be used for medical applications.

The compositions of the present invention can contain any combination of these or other additional active agents. The compositions can also contain additional components such as colorants, discoloration inhibitors, agents that affect the release or rate of release of the active agent, surfactants, adhesion agents, agents that enhance the activity of the active agent, solubilizing agents, agents that enhance the lubricity of the compositions, and other agents which provide beneficial properties to the compositions.

In some embodiments, the compositions can contain combinations of two or more of the additional active agents. Any combination that produces desired results may be used Some can include (along with the polymer and oligodynamic metal colloid): a combination of a biguanide (especially a chlorhexidine compound), a quaternary ammonium compound and a chlorinated phenol (for example, chlorhexidine with benzalkonium chloride and parachlorometaxylenol or triclosan); triclosan and another agent (for example ramicidin, polymixin, norfloxacin, sulfamylon, polyhexamethylene biguanide, alexidine, minocycline, iodine, benzalkonium chloride and rifampicin); chlorhexidine plus triclosan (optionally with silver sulfadiazine either as a part of the colloid or in addition to the colloid); combinations including a chlorhexidine free base and triclosan or a complex resulting from the combination of those two agents. Other examples can include silver sulfadiazine (either as a part of the colloid or in addition to the colloid) and sodium piperacillin; silver sulfonamides (either as a part of the colloid or in addition to the colloid) with piperacillin; silver (either as a part of the colloid or in addition to the colloid) with a chlorinated phenol and another antlinfective or antimicrobial agent.

It should be noted that for any term in the foregoing paragraphs that is expressed as a singular term but is sometimes interpreted as describing a class of compounds shall mean any of the group of compounds (e.g. all tetracyclines, all erythromycins, etc.).

### B. Preparation of Compositions Containing Additional Active Agents

The additional active agent or agents can be incorporated into the compositions of the present invention by any suitable method. For example, in an embodiment, the additional active agent or agents can be mixed with the components of the copolymer composition in a solvent suitable for both the composition and the active agent. Such solvents include, but are not limited to, those discussed above in the process for making the composition.

In some embodiments, the additional active agent or agents can be mixed with the monomers that form the copolymer prior to polymerization. In an embodiment, the additional active agent or agents will not be deactivated by polymerization conditions and will not interfere with polymerization The monomeric components can then polymerized by methods known in the art.

In some embodiments, the copolymer can be formed as described above, followed by addition of the additional active agent or agents to the copolymer solution

The additional active agent or agents may be soluble or insoluble in the polymer compositions of the invention or may be a combination of soluble and insoluble agents. Solubilized additional active agent or agents may be achieved by any means. In an embodiment, the additional active agent or agents can first be dissolved in a suitable solvent before addition to any of the solutions or suspensions used to produce the compositions of the invention. In some embodiments, an additional active agent or agents can be solubilized by adding the dry active agent directly to a solution of the compositions of the invention, in which it then dissolves.

In an embodiment, insoluble active agent or agents can be used. In some embodiments, the additional active agent or agents can be dispersed into a separate solvent before addition to the solutions or suspensions of the invention, or can be dispersed directly into any solution of the used to produce the compositions of the invention. Combinations of these techniques can also be used.

### III. Methods of Making Articles Including the Composition

In an embodiment, the present invention relates to an article of manufacture. In an embodiment, the antimicrobial composition can be used as a coating on a preformed article to provide antimicrobial activity to the surface of the article and to the environment surrounding the article through the continual release of oligodynamic ions. Any article can be coated with the antimicrobial compositions of the present invention. The composition is particularly suited for the production of medical devices, such as catheters including, but not limited to, urinary catheters, vascular catheters, dialysis catheters, and port catheters), cannulae, plugs, stents, syringes, guide wires, implant devices, contact lenses, IUDs, peristaltic pump chambers, endotracheal tubes, gastroenteric feeding tubes, endoscopes (including arthroscopes), arteriovenous shunts, condoms, oxygenator and kidney membranes, diagnostic instruments, gloves, pacemaker leads, and wound dressings.

The coatings can be applied to all or part of any surface or group of surfaces on an article. In some embodiments, one or more entire surfaces of an article are coated. In some embodiments, only part of one or more surfaces is coated. In some embodiments, some surfaces are coated in their entirety, while other surfaces are coated only partially. Any combination of surfaces, partial surfaces, or both may be selected for coating or remaining uncoated. Partial coating may be accomplished by, for example, dipping only part of an article into a coating composition or spraying a coating composition on to only a part of the article.

For example, in an embodiment in which underlying articles are transparent while coatings are opaque or translucent, a portion of the article may remain uncoated to allow visual inspection of the inside of those portions of the article, including any lumen therein. In an embodiment involving endotracheal tubes, for example, it may be desirable to leave a portion of the tube that will be outside the mouth of the patient uncoated so that it is possible to view the inner lumen of the tube to determine whether a patient is breathing properly.

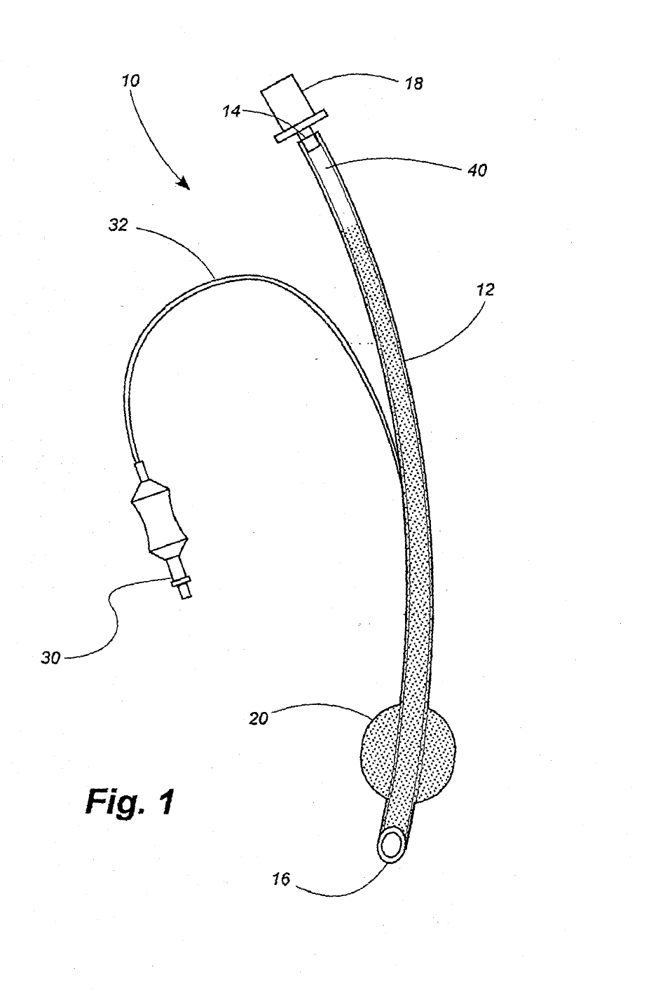

A non-limiting example of such an endotracheal tube 10 is shown in FIG. 1. The endotracheal tube comprises an elongate tubular body 12 having an upper end 14 and a lower end 16. A connector 18 is coupled to the body 12 at its upper end 14 for connecting the endotracheal tube to a mechanical ventilator. An inflatable cuff 20 is provided adjacent the lower end 16 of the endotracheal tube 10. The cuff 10 is inflated by means of a valve 30, which is in fluid communication with the cuff 20 by means of an inflation tube 32 and an inflation lumen (not shown) formed in the wall of the tubular body 12. The cuff is inflated in the conventional manner, such as by infusing a air through the valve 30 with a syringe.

The inner and outer surfaces of the endotracheal tube 10 can be dipped in a coating solution, such as the one of the compositions described herein, which can form an opaque or translucent layer when applied to the tube and permitted to dry. The dipping process can coat both the interior and exterior surfaces of the endotracheal tube 10. However, to prevent the entire endotracheal tube from becoming opaque, a portion 40 adjacent the upper end 14 of the tubular body 12 should not be coated. The uncoated portion may be provided in any suitable manner, such as by not dipping the upper portion 40 into the coating solution, or by masking the wall of the endotracheal tube adjacent the upper end to prevent the coating composition from coating the upper portion.

The resulting endotracheal tube can have an opaque coating applied to substantially the entire endotracheal tube except for the uncoated portion 40 which, when a patient is intubated and the tube is used in its normal manner, resides outside the patient. The physician can thus visualize the presence or absence of moisture or “fogging” through the uncoated walls of the upper portion 40, as an indication of whether the patient is breathing properly. In the disclosed embodiment of the endotracheal tube 10, the uncoated portion 40 is approximately five centimeters in length It will be understood, however, that the portion 40 can be shorter or longer, as appropriate, so long as at least a sufficient portion of the tube is coated to provide intended antimicrobial or other effects, and so long as at least a part of the uncoated portion 40 resides outside the patient when the tube is used normally and in its intended manner.

It will also be appreciated that the disclosed practice of leaving a portion of the endotracheal tube uncoated so as to visualize moisture or fogging through the walls of the tube is not limited to the disclosed coatings but includes other coatings, including but not limited to antimicrobial, bactericidal and germicidal coatings, coatings containing active agents of any type, lubricious coatings, and the like, especially coatings which are translucent or opaque when applied to the tube and permitted to dry.

While the embodiment disclosed above contemplates the coating of both the interior and exterior surfaces of the endotracheal tube 10, the invention is equally applicable to coatings which are applied only to the exterior surface or only to the interior surface of the tubular body 12.

In an embodiment, the composition of the invention can be prepared as a high solids solution and used alone or mixed with other polymers to form an article rather than a coating on an article.

In some embodiments, compositions of the invention can be admixed into latex rubber for fabrication of catheters, gloves, and other dipped latex products by standard form dipping methods, and vinyl plastisols can be mixed with compositions of the invention to provide dippable and castable antimicrobial PVC devices. Thus, the final article can be composed of one or more of the compositions of the present invention in admixture with other polymeric components.

In some embodiments, compositions of the invention can be formulated into high solids coating compositions that can be used to dip-fabricate a variety of medical devices, such as catheters, stents, gloves, condoms, and the like

In some embodiments, compositions of the invention can be dried and melt processed, for example, by injection molding, extrusion, or casting. Compositions used for this method can be used alone or compounded with any other melt-processable material for molding and extrusion of antimicrobial articles.

When used as a coating, the compositions can be applied by any means, including those methods known in the art. For example, the compositions can be brushed or sprayed onto the article, or the article can be dipped into the composition. Additionally, in some embodiments, the composition can be modified to keep the colloid dispersed for example by addition of an emulsifying agent, or by mechanical mixing or agitation. For example, the article can be dipped into the antimicrobial polymer solution at a rate of about 10-80 inches per minute (ipm). In an embodiment, the article can be dipped into the antimicrobial polymer solution at a rate of about 40 ipm. The article can remain in the antimicrobial polymer solution for a period of about 0-30 seconds. In an embodiment, the article can remain in the antimicrobial polymer solution for a period of about 5-15 seconds. The article can be withdrawn at a rate of about 10-80 ipm. In an embodiment, the article can be withdrawn at a rate of about 15-30 ipm. Once the article has been coated with the copolymer of the invention, it can optionally be air dried for a period of at least about 10 minutes before drying is completed in an oven for a period of about 5-60 minutes at a temperature in the range of about 40-100° C. Oven drying can occur for a period of about 15 minutes at a temperature of about 50° C. The coated article can optionally be dried with a hot air stream at a temperature in the range of approximately 40° C. to approximately 100° C. for a period of about 5-60 minutes to remove residual solvent. Persons skilled in the art will understand that the coating and drying parameters are merely examples and will vary based on the composition of the substrate, the coating, and the desired features of the coated objects. Drying as contemplated by the present invention includes any method wherein the composition solidifies by substantially removing or evaporating the liquid present in the composition.

The invention allows manipulation of the amount of oligodynamic metal compounds contained in the article per surface area (expressed in units such as micrograms of oligodynamic metal compound per square centimeter of surface area, or μg/cm2). Manipulation of this parameter provides an additional means of controlling release rate or release profile. Any achievable concentration of the amount of oligodynamic metal compounds contained in the article per surface area may be used. In some embodiments, the amount of oligodynamic metal compounds contained in the article per surface area may have upper and/or lower ranges or values of 4, 5, 7, 8, 10, 11, 13, 14, 15, 20, 25, 28, 30, 35, 40, 45, 50, 55, 60, 65, 70, 75, 80, 85, 90, 95, 100 μg/cm2 oligodynamic metal compound or compounds. In some embodiments, the article can contain from about 50 to about 100, about 50 to about 75, about 50 to about 60, or about 50 to about 60 μg/cm2 oligodynamic metal compound or compounds. In some embodiments, the article can contain from about 25 to about 50, about 40 to about 50, about 20 to about 30, about 25 to about 30, or about 30 to about 40 μg/cm2 oligodynamic metal compound or compounds In an embodiment, the article can contain between about the article can contain from about 10 to about 20, about 15 to about 20, or about 10 to about 15 μg/cm2 oligodynamic metal compound or compounds. In an embodiment, the article can contain between about the article can contain from about 5 to about 15, about 11 to about 14, about 5 to about 10, or about 4 to about 7 μg/cm2 oligodynamic metal compound or compounds In an embodiment, the article can contain about 8, 13, or 28 μg/cm2 oligodynamic metal compound or compounds. The foregoing ranges can be obtained with coated articles as well as with articles formed from the composition.

In some embodiments, antimicrobial medical devices can be obtained by the deposition of the antimicrobial metal directly onto the surface of the substrate, for example, by vapor coating, sputter coating, or ion beam coating. Another method of coating metal onto a substrate involves deposition or electrodeposition of the metal from solution.

In some embodiments, antimicrobial medical devices can be obtained by incorporation of metal, metal salts, and other antimicrobial compounds into a polymeric substrate material or coating from which the article is formed. An advantage of incorporating a metal into the coating, is that coatings comprising metal typically release, to varying degrees, the metal ions into the solution or tissue surrounding the substrate. An oligodynamic metal may be physically incorporated into the polymeric substrate in a variety of ways. For example, a liquid solution or suspension of the metal salt may be dipped, sprayed or brushed onto the solid polymer, for example, in pellet form, prior to formation of the polymeric article. Alternatively, a solid form of the metal salt can be mixed with a finely divided or liquefied polymeric resin, which is then molded into the article. Further, the oligodynamic compound can be mixed with monomers of the material prior to polymerization

In some embodiments, antimicrobial medical devices can be obtained by incorporation of oligodynamic agents into a polymeric coating which is then applied to the surface of the article. An oligodynamic agent can be incorporated into a coating solution in the form of a solution or a suspension of particles of the oligodynamic agent.

### IV. Methods of Using Articles Including the Composition

With many medical devices, it is beneficial to have a lubricious coating on the device, as lubricious coatings aid device insertion, reduce the trauma to tissue, and reduce the adherence of bacteria.

Further, antimicrobial articles, for example, urinary catheters, endotracheal tubes, and the like, can employ microbicidal agents that target the initial attachment of microorganisms to the article surface, commonly referred to as biofilm formation. Biofilm formation, for example, in the case of catheter-associated urinary tract infections (CAUTIs), typically occurs in several stages: initial attachment, microcolony formation, and development of mature biofilm. CAUTIs represent the most common nosocomial infection, with the risk of infection during short-term catheterization being about 5% per day. Strategies to control such infections include the use of antimicrobial coated catheters.

It may be desirable to provide an antimicrobial composition that may be incorporated into coatings and utilized in strategies to control infections such as, for example, catheter associated urinary tract infections, or endotracheal tube associated infections where the composition may prevent biofilm formation via different mechanisms.

In some embodiments, articles coated with the composition of the present invention can reduce adherence of one or more bacteria, fungi, or other microbes to the article as compared to uncoated articles. In some embodiments, the coating can result in an in vitro decrease in microbial adherence of 5-95%. In some embodiments, the coating can result in a decrease in microbial adherence of at least about 30%. In some embodiments, the coating can result in a decrease in microbial adherence of at least about 50%. In some embodiments, the coating can result in a decrease in microbial adherence of at least about 75%. In some embodiments, the coating can result in a decrease in microbial adherence of at least about 90%. In some embodiment, the coating can result in a reduction of at least about 95%. Embodiments with any degree of reduction of adherence can be used.

In some embodiments, articles coated with the composition of the present invention can have antimicrobial effects upon surrounding tissues and fluids, as can be demonstrated through zone of inhibition testing on one or more species or strains of bacteria, fungi, or other microorganisms. Examples of antimicrobial effects include, but are not limited to, inhibiting growth of microorganisms and can form a “zone of inhibition,” killing, and having other deleterious effect on microbes. In other embodiments, no zone of inhibition is created. In some embodiments, limited zones of inhibition can be created. Embodiments also exist in which zones of inhibition can be created for some strains in a species but not others, or for some species but not others. Embodiments also exist in which zones of inhibition differ between microbes. In some embodiments, an article is coated with a composition comprising colloidal gallium chloride. The resulting article reduces or eliminates adherence of microbes on the surface of the endotracheal tube but releases gallium to surrounding tissues at such a slow rate due to the low solubility of gallium chloride that the article does not produce zones in the zone of inhibition assay.

By tailoring the release profile of the oligodynamic metals, it is possible to develop an article having any combination of antimicrobial effects on the surface and surrounding tissues and fluids. Thus, any of the above combinations of effects can be achieved For example, in an embodiment, microbial adherence of a specific species or strain of organisms can be reduced (including any of the % reductions noted above) while these embodiments produce little or no zone of inhibition for the same species or strain. Embodiments also exist in which both zone of inhibition and microbial adherence can differ between organisms

In some embodiments, the use of the coatings can reduce the risk of infection. This action can operate by affecting the surface of the article, affecting surrounding tissues and fluids, or both. For example, use of endotracheal tubes containing a coating of the present invention can result in reduction of pneumonia occurrence as compared to uncoated tubes. This reduction can occur even though tubes with a similar or the same coating show limited or substantially no zone of inhibition in in vitro testing for the microbes administered to test subjects.

By reducing or eliminating the problems associated with conventional antimicrobial polymer compositions, the present invention can provide reproducible compositions having specific antimicrobial ion concentration with a specific antimicrobial ion release profiles that can be tailored through the specific salt combinations selected to provide optimum antibiotic activity over an extended period of time.

For example, the present invention can comprise methods of treatment and delivery of substances as well as devices in which anywhere from 5-100% of the oligodynamic metals in the compositions can be released in the first 24 hours A variety of release profiles from a single type of article can therefore be achieved. In some embodiments, about 75% to about 100%, about 50% to about 75%, about 25% to about 50%, or about 0% to about 25% of the oligodynamic metal in the coating can be released in the first 24 hours. In some embodiments, about 75% of the oligodynamic metal can be released in the first 24 hours. In some embodiments, about 40% of the oligodynamic metal can be released in the first 24 hours. Embodiments can involve releases over a longer period of time. In one embodiment, about 38% can be released the first day, and about 80% of the oligodynamic metal can be released within 21 days.

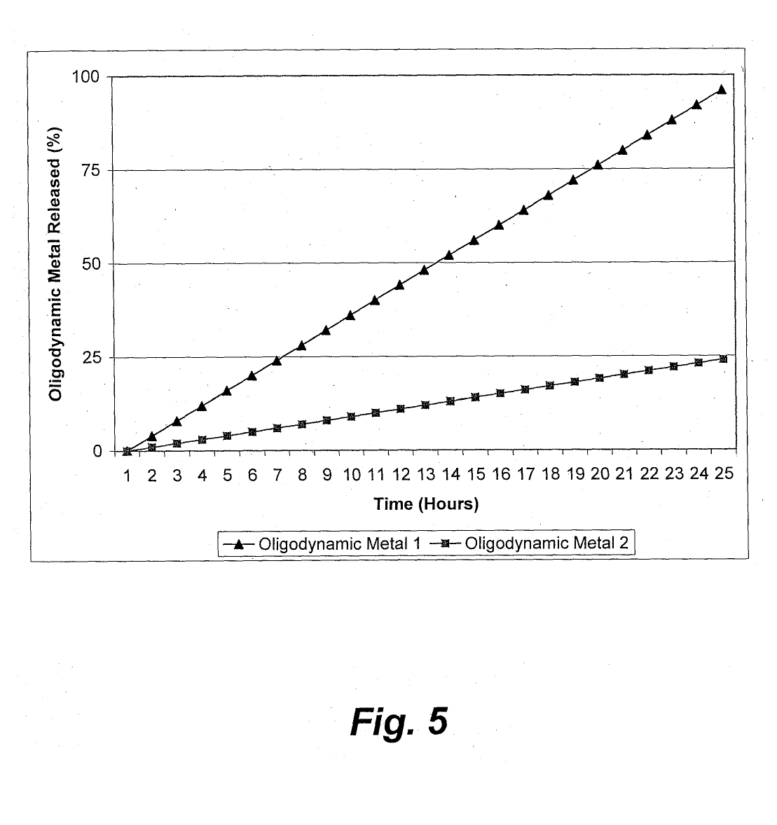

In an embodiment, the release profile of gallium and additional oligodynamic metals in the coating may be staggered, i.e., the release profile of gallium can occur such that between about 75% and about 100% of the gallium in the coating is released in the first 24 hours, and between about 0% and about 25% of the additional oligodynamic metals are released in the first 24 hours. As an example, FIG. 5 depicts an embodiment illustrating staggered release profiles

A tailored delivery embodiment of the invention is described below in Example 5 in terms of a polyurethane composition containing a colloid of specific gallium salts. It is to be understood that this is simply an example of one embodiment of the invention and that one of skill in the art, based upon the present disclosure, can pick and choose salts having differing solubilities, and further may combine additional salts to provide a composition having a suitable release profile and treatment for a particular purpose

The initial release and the duration of release of the oligodynamic agents from the composition depends upon several factors. These factors include the relative water solubilities of the particular salts formed in the colloid and the concentration of the salts in the colloid. This release can range, for example, from a few days to several months, and can be tailored through the choice and number of salts formed in the composition for the intended purpose of the device to be coated.

The compositions of the invention can also be tailored to provide other desired properties, such as surface lubricity. Further, the compositions may contain other medicinal or otherwise beneficial agents

An advantage of the coating compositions is the wet coefficients of friction (COF) are achievable. Coating compositions can be manipulated so that highly lubricious coatings are made, or hydrophilic coatings with little lubricity are made. Embodiments exist with any achievable COF value. In medical device embodiments, upper and/or lower ranges or COF values of 0.040, 0.060, 0.100, 0 200, 0.300, 0.337, 0.373, 0.400 are contemplated. In some embodiments, intermediary COF values ranging from about 0.100 to about 0.030 can be used to reduce the risk of unwanted slippage or movement of a coated article after placement in a location in the body such as a cavity or lumen while providing enough hydrophilicity to reduce tissue irritation and inflammation. In some embodiment where a highly lubricious surface is desired, a COF ranging from about 0.040 to about 0.060 (after one hour immersion in water) can be used. In some embodiments, COF values ranging from about 0.300 to about 0.400, about 0.100 to about 0.200, about 0.200 to about 0.300, about 0.337 to about 0.373, about 0.040 to about 0.060, or about 0.100 to about 0.300 (after one hour immersion in water) can be used.

Additionally, compositions of the invention can be tailored to release the bulk of their oligodynamic agents within 5 days for a medical device with a short term use in the body, such as a wound drain, within 14 days for a device such as an endotracheal tube with an intermediary term use, or within 30 days for a device with a longer term use, such as a foley catheter Longer and shorter terms are possible.

A. Methods of Using the Compositions with Additional Active Agents

As discussed above, in an embodiment, the compositions of the present invention can be coated onto the surface of a substrate or used to form an article. Additionally, as discussed in detail above, the compositions can contain additional active agents.

In an embodiment, an article can first be coated with a layer of silver as described, for example, in U.S. Pat. Nos. 5,395,651; 5,747,178; and 5,320,908 to Sodervall et al., the disclosures of which are incorporated by reference herein. The composition of the present invention can then coated over the silver coated article in a manner as described above.

In an embodiment, the compositions of the invention comprising the active agent can be used in combination with one or more additional coating compositions to coat a surface. Alternatively, the composition can be used to form an article to which one or more coatings is thereafter applied. The following is a description of some of the possible coating combinations contemplated by the present invention. This description exemplifies the invention in terms of two layers, a primer or base coat and a top coat. However, the invention encompasses the use of more than two layers, any of which can include the active agents of the present invention. The following combinations of coatings are not intended to be exclusive. One having ordinary skill in the art with the following information would readily recognize additional combinations and be capable of practicing the present invention with such additional combinations Therefore, any combination of coatings may be used.

Some multi-coating embodiments comprise the use of two compositions to provide two distinct coatings on the device or a formed article and a coating. It should be understood that the invention can also be practiced with multiples layers following the same principles as described below.

The coatings may contain the same composition or different compositions, so long as at least one of the coatings comprises the composition of the present invention. Where two or more coating layers are employed in the invention, it is convenient to refer to the coating layer closest to the substrate surface as a primer or base coat and to the coating layer most exterior as the top coat.

The compositions of the present invention can be employed as the base coat, the top coat, or both. They can also be employed as intermediate coating layers when used with other coatings of the present invention or known in the art.

In an embodiment, the substrate base coat comprises a polymeric composition that improves adherence of the other coating layers to the article In an embodiment, top coats that provide a dry elastic coating that becomes lubricious when wet.

Any of the coating layers can comprise one or more active agents in addition to the colloid. Where multiple coatings contain an active agent, the active agents in the coatings may be the same or different. Further, one or more of the coatings can contain additional agents that provide advantageous properties to the device For example, any of the coatings, regardless of whether they contain additional active agents, can also contain agents that affect the release or rate of release of the active agent. The coatings can also contain agents that improve adhesion of the coatings to the substrate or to the base coat, improve wet lubricity of the surface, inhibit discoloration of the compositions containing active agents that discolor, provide additional therapeutic activity, enhance the activity of the active agent, provide galvanic action for oligodynamic metal, and the like.

Further, the particular polymeric compositions of the coatings can be designed to provide some of the properties listed above, such as improved adhesion, improved lubricity, or to enhance or inhibit release of the active agent.

As with coatings that do not contain additional active agents, an embodiment includes substrates which are medical devices. Exemplary medical devices have been described in detail above, and need not be repeated. Use of particular additional active agents in the various coating layers provides particular beneficial effects For example, use of antibiotics or antimicrobials, can inhibit the adherence of bacteria to the surface of the device and can prevent infection in the surrounding tissue.

Although the compositions of the present invention have many applications in connection with medical devices, their use is not limited to such embodiments In an embodiment, the compositions of the present invention can be used to coat consumer products and other surfaces to provide an active agent on the surface. The compositions may be used for any suitable purposes. In some embodiments, the compositions of the present invention are used to coat glass beads, chromatography packing material, and other substances for use as diagnostic agents. An example of such embodiments is use of active agents incorporated in such compositions that can detect the desired chemical or substance to be detected. Detection of the appropriate substance can be performed by conventional methods, such as ELISA assays, radioimmunoassays, NMR, fluorescent spectroscopy, and the like.

While an embodiment includes dip coating medical devices, such as catheters and stents, the compositions of the present invention can be coated by any other means including, but not limited to spray or brush coatings.

Other applications for which the copolymer compositions of the present invention are useful include coating the compositions onto surfaces in contact with bodies of water such as the walls of pools or spas, the hulls of boats or ships, and the like to provide algaecidic activity, antifoulant activity, or both. For example, the coatings of the invention can be applied to ship hulls to prevent attachment of invertebrate encrustation (e.g., arthropod or molluscan encrustation), or to pool liners to prevent bioslime.

### B. Other Methods of Using the Composition

Methods of use of compositions of the present invention and articles comprising those compositions also include, but are not limited to, methods of delivering oligodynamic metals, in forms including, but not limited to, ions, salts and esters of one or more oligodynamic metals or combinations thereof, to a desired location as well as methods of treatment of cells, tissues, and organisms.

In some embodiments in which compositions contain additional active agents, the compositions of the present invention can also be used as delivery agents to deliver one or more active agents to a desired location. The method includes delivery of any active agent or combination of agents, including any of the active agents listed above. In some embodiments, the methods provide delivery of beneficial agents to patients. For such uses, the compositions of the present invention are used, for example, as coatings on substrates, such as medical devices, bandages, or devices known in the art for topical delivery of pharmaceutical agents or to form the articles or parts of such articles.

Some embodiments of methods involve delivery of substances to one or more desired locations. Delivered substances include, but are not limited to, compositions comprising both the polymers and the colloids of oligodynamic compounds, the oligodynamic metal compounds themselves, or oligodynamic metal ions. In some embodiments in which the composition contains one or more additional active agents, the delivered substances include such agent or agents An embodiment of locations include, but are not limited to, an orifice, tissue, cavity, fluid, or other component of the body of an organism. Other methods can include, but are not limited to, in vitro delivery to tissues, tissue cultures, suspensions of cells, or other substances or preparations. In some embodiments, methods include placing a composition of the present invention in conditions effective to cause delivery of one or more oligodynamic metals or ions, salts or oxides thereof (optionally including additional active agents as well) to the desired location Examples of such conditions include, but are not limited to an aqueous fluid that will allow diffusion of the oligodynamic metal ions or one or more other active agents from the composition and a location in the body of an organism that will allow diffusion of oligodynamic metal salts or oxides or one or more other active agents into a tissue or a fluid in the body.

Methods of the present invention can be useful in treatments of organisms, cells, or tissues. An example of such methods involves placing the polymer composition comprising one or more oligodynamic metal compounds and one or more other active agents, or articles comprising such compositions, under conditions effective to deliver ions or compounds of oligodynamic metals to the target organisms, cells, or tissues. Such compositions may, for example, be implanted, administered, inserted, or otherwise placed in conditions effective to cause the oligodynamic metal salts or ions or one or more other active agents to be delivered to the cells, tissue, organisms, or parts of organisms. Examples of treatments include, but are not limited to, for example, antifungal treatments, antiviral treatments, anti-inflammatory treatments, anesthetic treatments, antiseptic treatments, analgesic treatments, stimulant treatments, depressant treatments, tranquilizer treatments, hormone administration, germicidal treatments, antiprotozoal treatments, antiviral treatments, antineoplastic treatments, antiparasitic treatments, antirheumatic treatments, antibacterial treatments, emetic treatments, antiseptic treatments, treatments for inhibiting restenosis, methods of inhibiting healing, methods of reducing thrombus formation, methods of anticoagulation, methods of reducing encrustation, methods of providing topical protection, methods of deodorization (e.g. of wounds or ulcers), methods of preventing or combating infection, methods of preventing or combating microbial or parasitic infestation, methods of promoting healing, methods of producing a styptic or astringent effect, methods of causing formation of eschars or scars, methods of preventing the formation of eschars or scars, methods of contraception, and methods of treating ulcers, slowly granulating wounds, vaginitis, fistulas, dermatitis, or popodermatitis. Additional examples regarding treatments are disclosed in the discussion of the effects of the composition above, and in the example below.

Any of the terms used in the preceding paragraphs to describe effects or treatments are defined to have their broadest possible meanings. Terms that refer to being “anti” a type of target organism or agent (e.g., antimicrobial, antiviral, antibacterial) refers to having any deleterious effects upon those organisms or their ability to cause symptoms in a host or patient. Examples include, but are not limited to, inhibition or prevention of growth or reproduction, killing, and inhibiting any metabolic activity of the target organisms. Terms that refer to being “anti” a type of symptom or condition, or as being a “treatment” for a type of condition or symptom, include but are not limited to any effect that prevents, reduces, cures, accelerates cure or healing, or reduces the severity of one or more conditions or symptoms

As discussed above, the use of salts and esters of differing solubilities allows control of release profiles of oligodynamic metals. The methods, compositions, and articles herein may also include other means of controlling release profiles. In some embodiments, articles comprising the compositions are shaped in a specific way to affect release profile. For example, diffusion of oligodynamic metals (and, optionally, one or more other active agents) from polymer compositions comprising the salts is enhanced by fragmenting or pulverizing the polymer compositions. In some embodiments, pulverized compositions are applied to a wound site, ingested, or formed into another shape such as a capsule or a tablet. In other embodiments, release is affected by applying an elevated or reduced temperature, an electric field, a magnetic field, or an electric current to the oligodynamic metal compositions before, during, or after application. Release is also affected by coating compositions and articles with other substances or preparing laminates in which layers have different release profiles or combinations thereof. Layering an object with one or more coatings that dissolve over a given period of time, for example, affords another level of control of release profile. The coatings, envelopes, and protective matrices may be made, for example, from polymeric substances, waxes, oligomeric substances, or combinations thereof. The compositions may also contain additional chemicals that affect the release profile of the oligodynamic metal compounds.

Methods of treatment and methods of delivery of oligodynamic metal salts and esters (and, optionally, one or more other active agents) can include release from articles and/or medical devices described in detail above containing the compositions. The compositions of the present invention may be combined with pharmaceutically or cosmetically acceptable carriers and administered as compositions in vitro or in vivo.

Forms of administration include but are not limited to implantation or insertion of a medical device comprising the composition, injections, solutions, lotions, slaves, creams, gels, implants, pumps, ointments, emulsions, suspensions, microspheres, particles, microparticles, nanoparticles, liposomes, pastes, patches, tablets, transdermal delivery devices (such as patches), sprays, aerosols, or other means familiar to one of ordinary skill in the art. Such pharmaceutically or cosmetically acceptable carriers are commonly known to one of ordinary skill in the art. Pharmaceutical formulations of the present invention can be prepared by procedures known in the art using well known and readily available ingredients. For example, the compounds can be formulated with common excipients, diluents, or carriers, and formed into tablets, capsules, suspensions, powders, and the like. Examples of excipients, diluents, and carriers that are suitable for such formulations include the following: fillers and extenders (e.g., starch, sugars, mannitol, and silicic derivatives); binding agents (e.g., carboxymethyl cellulose and other cellulose derivatives, alginates, gelatin, and polyvinyl-pyrrolidone); moisturizing agents (e.g., glycerol); disintegrating agents (e.g., calcium carbonate and sodium bicarbonate); agents for retarding dissolution (e.g., paraffin); resorption accelerators (e.g., quaternary ammonium compounds); surface active agents (e.g., cetyl alcohol, glycerol monostearate); adsorptive carriers (e.g., kaolin and bentonite); emulsifiers; preservatives; sweeteners; stabilizers; coloring agents; perfuming agents; flavoring agents; dry lubricants (e.g., talc, calcium and magnesium stearate); solid polyethyl glycols; and mixtures thereof.

The terms “pharmaceutically or cosmetically acceptable carrier” or “pharmaceutically or cosmetically acceptable vehicle” are used herein to mean, without limitations, any liquid, solid or semi-solid, including but not limited to water or saline, a gel, cream, salve, solvent, diluent, fluid ointment base, ointment, paste, implant, liposome, micelle, giant micelle, and the like, which is suitable for use in contact with living animal or human tissue, desirably without causing excessive adverse physiological or cosmetic responses, and without excessively interacting with the other components of the composition in a deleterious manner. Other pharmaceutically or cosmetically acceptable carriers or vehicles known to one of skill in the art may be employed to make compositions for delivering the molecules of the present invention.

In an embodiment, formulations can be constituted so that they can release the active ingredient only or in a particular location, over a period of time, or a combination thereof. Such combinations can provide yet a further mechanism for controlling release kinetics.

Methods of in vivo administration of the compositions of the present invention, or of formulations comprising such compositions and other materials such as carriers of the present invention that are particularly suitable for various forms include, but are not limited to, urethral administration, oral administration (e.g. buccal or sublingual administration), anal administration, rectal administration, administration as a suppository, topical application, aerosol application, inhalation, intraperitoneal administration, intravenous administration, transdermal administration, intradermal administration, subdermal administration, intramuscular administration, intrauterine administration, vaginal administration, administration into a body cavity, implantation, surgical administration at the location of a tumor or internal injury, administration into the lumen or parenchyma of an organ, and parenteral administration. Techniques useful in the various forms of administrations above include but are not limited to, topical application, ingestion, inhalation, insertion, surgical administration, injections, sprays, transdermal delivery devices, osmotic pumps, applying directly on a desired site, or other means familiar to one of ordinary skill in the art. Sites of application can be external, such as on the epidermis or into an orifice, or internal, for example a gastric ulcer, a surgical field, or into the lumen of a duct or organ, or elsewhere.

The compositions of the present invention can be applied in the form of creams, gels, solutions, suspensions, liposomes, particles, or other means known to one of skill in the art of formulation and delivery of therapeutic and cosmetic compounds Ultrafine size particles containing the composition can be used for inhalation delivery Some examples of appropriate formulations for subcutaneous administration include but are not limited to implants, depot, needles, capsules, and osmotic pumps. Some examples of appropriate formulations for vaginal administration include but are not limited to creams, cervical caps, and rings. Some examples of appropriate formulations for oral administration include but are not limited to: pills, liquids, syrups, and suspensions. Some examples of appropriate formulations for transdermal administration include but are not limited to creams, pastes, patches, sprays, and gels. Formulations suitable for parenteral administration include but are not limited to aqueous and non-aqueous sterile injection solutions which may contain anti-oxidants, buffers, bacteriostats and solutes which render the formulation isotonic with the blood of the intended recipient; and aqueous and non-aqueous sterile suspensions which may include suspending agents and thickening agents. Extemporaneous injection solutions and suspensions may be prepared from sterile powders, granules and tablets commonly used by one of ordinary skill in the art

In an embodiment, compositions of the invention can be combined with, for example, one or more pharmaceutically or cosmetically acceptable carriers or excipients may conveniently be presented in unit dosage form and may be prepared by conventional pharmaceutical techniques. Such techniques include the step of bringing into association the compositions containing the active ingredient and the pharmaceutical carrier(s) or excipient(s). In general, the formulations are prepared by uniformly and intimately bringing into association the active ingredient with liquid carriers. An embodiment of unit dosage formulations are those containing a dose or unit, or an appropriate fraction thereof, of the administered ingredient. It should be understood that in addition to the ingredients particularly mentioned above, formulations comprising the compositions of the present invention may include other agents commonly used by one of ordinary skill in the art. The volume of administration will vary depending on the route of administration. For example, intramuscular injections may range in volume from about 0.1 ml to 1.0 ml.

### Example 1

Example 1 demonstrates the antimicrobial activity of gallium. In this example, microorganisms (Escherichia coli 6418) were grown in growth media containing different concentrations of gallium nitrate (Ga(NO3)3) After 24 hours, the number of viable microorganisms was determined by plate counting.

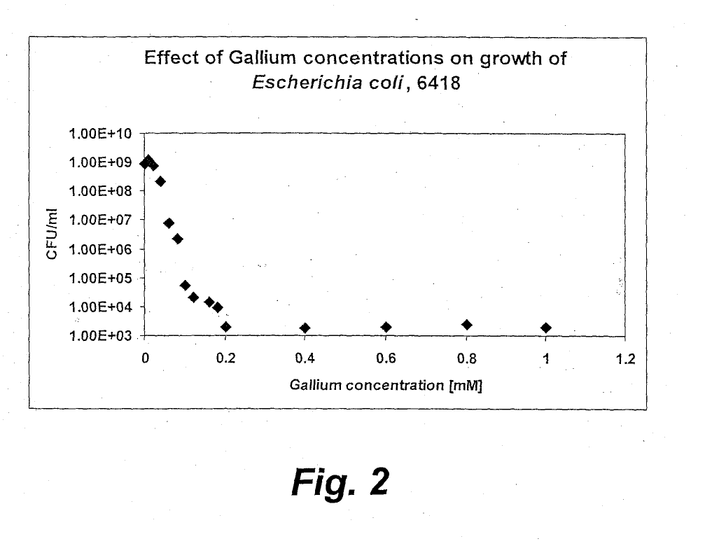

The results of Example 1 are shown in the graph in FIG. 2. As indicated in FIG. 2, gallium showed antimicrobial activity between a concentration of about 0 06 mM and about 1.0 mM. Maximum inhibition of microorganisms was observed between about 0.2 mM and about 1.0 mM.

Example 2

Example 2 demonstrates the competitive interference of gallium with iron metabolism. Example 2 further demonstrates the inhibitory effect of gallium can be reversed by addition of iron with gallium. Thus, the combination of gallium and iron by this example is an indicator of competitive inhibition between iron and gallium.

In this example, a hydrogel coated latex foley catheter was incubated with either growth media alone (positive control), growth media with 0.2 mM gallium nitrate, or growth media with 0.2 mM gallium nitrate and an equimolar amount of iron (III) nitrate and the media were inoculated with Escherichia coli 6418. After 48 hours, catheter pieces were removed, microorganisms were recovered from the catheter surface and enumerated by plate counting methods.

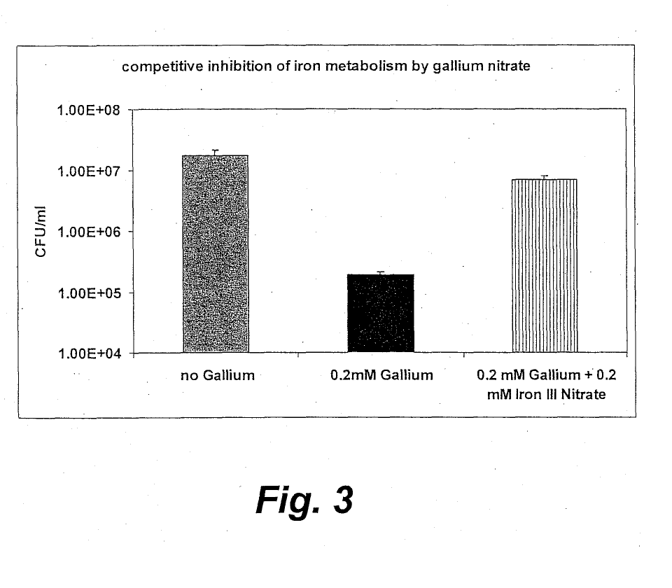

The results of Example 2 are shown in the graph in FIG. 3. As indicated in FIG. 3, reduced microbial colonization of the catheter surface was observed with the 0.2 mM gallium nitrate catheter as compared to the positive control with no gallium. However, addition of iron (III) nitrate reversed this inhibitory effect and microbial colonization of the catheter was comparable to the positive control without gallium.

### Example 3

Example 3 demonstrates the impact of gallium on biofilm formation. Example 3 was prepared in the same manner as in Example 2, but the catheters were first incubated in inoculated media without gallium or iron nitrate for two hours, so that bacteria could attach to the surface before transferring on media with gallium or gallium and iron (III) nitrate. After 48 hours, catheter pieces were removed, microorganisms were recovered from the catheter surface and enumerated by plate counting methods.

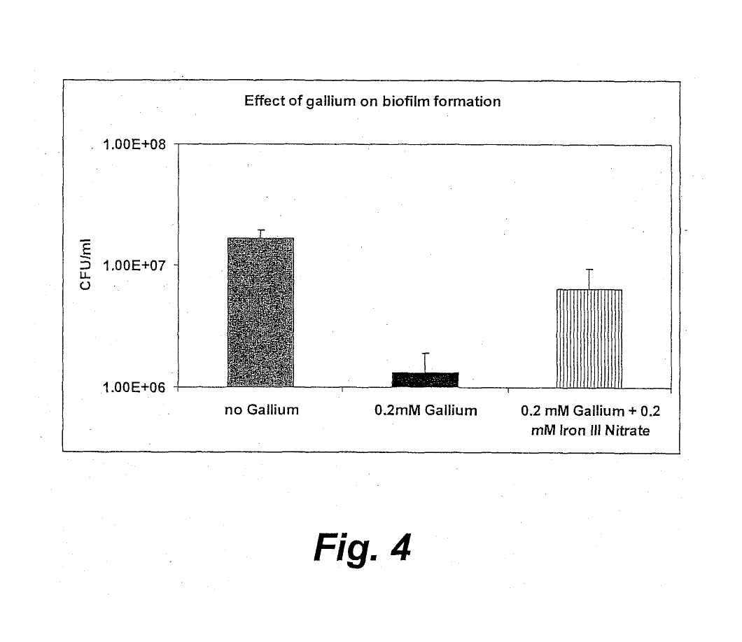

The results of Example 3 are shown in the graph in FIG. 4. As indicated in FIG. 4, reduced biofilm formation was observed with 0.2 mM gallium nitrate as compared to the positive control with no gallium. However, addition of iron (III) nitrate reversed this inhibitory effect.

### Example 4

Example 4 is a prophetic example, and demonstrates an endotracheal tube partially coated with a coating in accordance with some embodiments of the present invention, as shown in FIG. 1.

The endotracheal tube of Example 4 is coated with a hydrogel (PVP polymer) coating. The coating is formed from a 4.7% solution of a polyether polyurethane-urea block copolymer and prepared in a mixture of THF/ethanol in a 75/25 ratio by weight. A sufficient quantity of 10% gallium nitrate (Ga(NO₃)₃) solution in water is added to the CardioTech copolymer solution to produce a final gallium concentration of approximately 15%, based on coating solids in the solution. An aqueous solution of 1.0% sodium chloride (NaCl) is then slowly added to the solution with stirring in an amount sufficient to react with 50% of the Ga(NO₃)₃, resulting in a gallium concentration of approximately 1 mM in the coating The endotracheal tube of Example 4 will inhibit biofilm formation of both Mycobacterium tuberculosis in addition to M. avium complex (MAC).

### Utility Examples

### Example 5

The process of the invention will now be further described in a prophetic example in terms of the formation of a colloid of gallium chloride from gallium nitrate and sodium chloride in a polyurethane polymer coating solution. It is to be understood that this is simply an example of an embodiment of the invention and that any polymer or combination of polymers and any mixture of salts that will form a colloid within the polymer solution can be employed in the present invention.

First, a 4.7% solution of a polyether polyurethane-urea block copolymer is prepared in a mixture of THF/ethanol in a 75/25 ratio by weight A sufficient quantity of 10% gallium nitrate (Ga(NO3)3) solution in water is added to the CardioTech copolymer solution to produce a final gallium concentration of approximately 15%, based on coating solids in the solution.

An aqueous solutions of sodium chloride, zinc iodide, sodium citrate, sodium acetate, and sodium lactate (each 1.0% solutions) can then be slowly added to the solution in sufficient amounts for each salt to react with 15% of the gallium nitrate Ga(NO3)3. Colloids of gallium chloride, gallium iodide, gallium citrate, gallium acetate, and gallium lactate are formed in the final coating composition. The coating composition also contains 25% unreacted soluble gallium nitrate, as well as the gallium nitrate and zinc nitrate salt products. The differences in the solubility of the different salts in the composition will result in different and prolonged rates of release of the oligodynamic gallium in the coating composition when a device coated with the composition is exposed to body fluid. The amount of water in the final coating solution is about 30% of the total solvent weight. The final polymer concentration in the coating solution is about 3.3%, based upon solvent and polymer weights.

The most water soluble salt of the salts present in the above noted composition is gallium nitrate and is typically released rapidly upon initial exposure of the coating to body fluid. Sodium lactate, which has a lower solubility in water than gallium nitrate but a higher solubility than the other salts present, will likely be released next. Then, the gallium acetate, followed by the gallium citrate, and then the gallium chloride, and, lastly, the gallium iodide will likely be released from the coating composition based upon their relative solubilities in water.

A 16 Fr latex Foley catheter is then coated with the composition by dipping it into the composition solution, withdrawing it at a controlled rate and drying it using standard methods. The finished coating will contain both the water soluble, and therefore fast releasing, Ga(NO3)3, and the water insoluble, and therefore slow releasing, GaCl.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

1. A composition comprising: at least one polymer; and a colloid comprising a gallium compound; wherein the composition exhibits an antimicrobial effect.

2. The composition of claim 1, wherein the gallium in the gallium compound is present in a concentration from about 0 01 to about 4 mM with respect to the composition.

3. The composition of claim 1, wherein the gallium in the gallium compound is present in a concentration from about 0 06 to about 0 2 mM with respect to the composition.

4. The composition of claim 1, wherein the gallium compound comprises at least one salt or ester of gallium.

5. The composition of claim 4, wherein the gallium compound comprises at least one of gallium nitrate, gallium chloride, gallium iodide, gallium citrate, gallium acetate, and gallium lactate.

6. The composition of claim 1, wherein the colloid further comprises at least one oligodynamic metal compound.

7. The composition of claim 6, wherein the at least one oligodynamic metal compound is chosen from silver, platinum, gold, zinc, copper, cerium, osmium, or mixtures thereof.

8. The composition of claim 7, wherein the at least one oligodynamic metal comprises at least one silver compound which is a salt or ester of silver.

9. The composition of claim 8, wherein the silver compound comprises at least one of silver chloride, silver iodide, silver citrate, silver lactate, silver acetate, silver propionate, silver salicylate, silver bromide, silver ascorbate, silver lauryl sulfate, silver phosphate, silver sulfate, silver oxide, silver benzoate, silver carbonate, silver sulfadiazine, and silver gluconate.

10. The composition of claim 8, wherein the silver compound is silver chloride in an amount of from about 4% to about 6% based on the total weight of solids in the composition.

11. The composition of claim 6, wherein the gallium compound and the at least one oligodynamic metal compound have different solubilities in water.

12. The composition of claim 1, wherein the at least one polymer comprises at least one of polyurethanes, including polyether polyurethanes, polyester polyurethanes, polyurethaneureas and their copolymers, polyvinylpyrrolidones, polycarbonates, acrylates, polyvinyl alcohols, polyethylenes, polyethylene glycols and their copolymers, polypropylene glycols and their copolymers, polyoxyethylenes and their copolymers, polyacrylic acid, polyacrylamide, glycoproteins, proteoglycans, glycosaminoglycans, lipoproteins, liposaccharides, cellulose and its derivatives, dextrans, polysaccharides, starches, guar, xantham and other gums, collagen, gelatins, polytetrafluoroethylenes, polyvinyl chloride, polyvinyl chloride plastisol, polyvinylacetate, poly(ethylene terephthalate), silicone, polyesters, polyamides, polyureas, styrene-block copolymers, polymethyl methacrylate, acrylic-butadiene-styrene copolymers, polyethylene, polystyrene, polypropylenes, natural and synthetic rubbers, latex rubber, acrylonitrile rubber, and mixtures and derivatives and copolymers thereof.

13. An article comprising the composition of claim 1.

14. The article of claim 13, wherein the article comprises a substrate material and a coating comprising a composition comprising: at least one polymer; and a colloid comprising a gallium compound; wherein the composition exhibits an antimicrobial effect, on at least part of one or more surfaces of the substrate material.

15. The article of claim 14, wherein the surface of the substrate material is not completely covered.

16. The article of claim 15, wherein a part of the surface that is not covered is sufficiently transparent to allow visual inspection of the interior of the article.

17. The article of claim 14 wherein the coating comprises at least two layers.

18. The article of claim 13 wherein the article comprises a medical device.

19. The article of claim 18, wherein the medical device is chosen from endotracheal tubes, catheters, stents, syringes, guide wires, intrauterine devices, peristaltic pump chambers, gastroenteric feeding tubes, endoscopes, and arteriovenous shunts.

20. The article of claim 13, wherein the gallium in the gallium compound is present in a concentration from about 0 06 to about 0 2 mM with respect to the composition.

21. A method of manufacturing an article comprising: preparing a liquid comprising a composition; wherein said composition comprises at least one polymer and a colloid comprising a gallium compound; and drying the liquid to create an article.

22. A method of manufacturing an article comprising: applying the composition of claim 1 to a substrate; and drying the composition to form the article.

23. A method of manufacturing an article comprising: applying the composition of claim 1 to a substrate; and forming the composition on the substrate; and drying the composition to form the article.

24. The method of manufacturing an article of claim 22, wherein drying the composition comprises applying heat.

25. The method of manufacturing an article of claim 23, wherein drying the composition comprises applying heat.

26. The method of manufacturing an article of claim 22, wherein applying the composition comprises at least one of spraying and dipping.

27. The method of manufacturing an article of claim 23, wherein applying the composition comprises at least one of spraying and dipping.

28. A method of manufacturing an article comprising dipping a form in the composition of claim 1.

29. The method of claim 28, wherein the composition is removed from the form.

30. The method of manufacturing an article according to claim 21 comprising injection molding, extruding, or casting a composition comprising: at least one polymer; and a colloid comprising a gallium compound; wherein the composition exhibits an antimicrobial effect, into a shape.

31. A method for delivery of one or more oligodynamic compounds comprising gallium comprising: implanting, administering, inserting, or placing the composition of claim 1 under conditions effective to deliver the gallium to a desired location.

32. The method for delivery of claim 31, wherein the gallium compound comprises at least one of gallium nitrate, gallium chloride, gallium iodide, gallium citrate, gallium acetate, and gallium lactate.

33. A method of treating at least one cell, tissue, organism, or portion of the cell, tissue, or organism, comprising implanting, administering, inserting, or otherwise placing the composition of claim 1 under conditions effective to deliver gallium to the cell, tissue, organism, or portion of the cell, tissue, or organism.

34. A method of preparing an antimicrobial composition comprising: mixing at least one polymer with a liquid comprising at least one oligodynamic agent comprising a gallium compound.

35. The method of claim 34, wherein said oligodynamic agent comprising a gallium compound is present in a colloid.

36. The method of claim 35, wherein said colloid is formed by adding at least one salt comprising a cation chosen from calcium, sodium, lithium, aluminum, magnesium, potassium, manganese, silver, platinum, gold, cerium, osmium, copper, zinc, and gallium.

37. The method of claim 36, wherein the at least one salt further comprises an anion chosen from oxides, acetates, acetylsalicylates, ascorbates, benzoates, bitartrates, bromides, carbonates, chlorides, citrates, folates, carbonates, deoxychoiates, gluconates, iodates, iodides, lactates, laurates, oxalates, palmitates, para-aminobenzoates, para-aminosalicylates, perborates, phenosulfonates, phosphates, picrates, propionates, salicylates, stearates, succinates, sulfadiazines, sulfates, sulfides, sulfonates, tartrates, thiocyanates, thioglycolates, thiosulfates, and silver ethylenediaminetetraacetic acid, and combinations thereof.

38. The method of claim 36, wherein said at least one salt is added to the liquid comprising at least one oligodynamic agent comprising gallium after the gallium compound is mixed with the at least one polymer.

39. The method of claim 36, wherein said at least one salt is added to the liquid comprising at least one oligodynamic agent comprising gallium before the gallium compound is mixed with the at least one polymer.
